(19) United States
(12) Patent Application Publication
(10) Pub. No.: US 2025/0038815 A1
(43) Pub. Date: Jan. 30, 2025

(54) WIRELESS COMMUNICATION METHODS, TERMINAL DEVICES AND NETWORK DEVICES

(71) Applicant: GUANGDONG OPPO MOBILE TELECOMMUNICATIONS CORP., LTD., Dongguan (CN)

(72) Inventors: Jing XU, Dongguan (CN); Yanan LIN, Dongguan (CN)

(21) Appl. No.: 18/916,706

(22) Filed: Oct. 16, 2024

Related U.S. Application Data
(63) Continuation of application No. PCT/CN2022/100157, filed on Jun. 21, 2022.

(51) Int. Cl. H04B 7/06; H04L 5/00

(52) U.S. Cl. CPC H04B 7/0626; H04L 5/0053

(57) ABSTRACT

A wireless communication method includes: receiving, by a terminal device, first control information, where the first control information is used to schedule a plurality of uplink channels, and different uplink channels of the plurality of uplink channels are carried by different carriers; and determining, by the terminal device, at least one uplink channel from the plurality of uplink channels, where the at least one uplink channel is at least used to carry CSI; and transmitting at least, by the terminal device, the at least one uplink channel, where the at least one uplink channel carries the CSI to be transmitted.

### CROSS-REFERENCE TO RELATED APPLICATION

This application is a Continuation application of International Application No. PCT/CN2022/100157 filed on Jun. 21, 2022, which is incorporated herein by reference in its entirety.

### TECHNICAL FIELD

Embodiments of the present application relate to the field of communications, and more specifically, to a wireless communication method, a terminal device, and a network device.

### BACKGROUND

At present, channel state information (CSI) reporting based on a physical uplink shared channel (PUSCH) in a new radio (NR) system supports that one downlink control information (DCI) schedules a PUSCH on one carrier. However, in dual connectivity (DC)/carrier aggregation (CA) enhancement, it is supported that one DCI schedules PUSCHs of a plurality of carriers. In this case, how to report CSI is a problem that needs to be solved.

### SUMMARY

In a first aspect, a wireless communication method is provided, and the method includes:
receiving, by a terminal device, first control information, where the first control information is used to schedule a plurality of uplink channels, and different uplink channels of the plurality of uplink channels are carried by different carriers;
determining, by the terminal device, the at least one uplink channel from the plurality of uplink channels, where the at least one uplink channel is at least used to carry CSI; and
transmitting at least, by the terminal device, the at least one uplink channel, where the at least one uplink channel carries the CSI to be transmitted.

In a second aspect, a terminal device is provided, and includes a processor and a memory; the memory is configured to store a computer program, and the processor is configured to invoke and execute the computer program stored in the memory, to cause the terminal device to perform the method in the above first aspect.

In a third aspect, a network device is provided, and includes a processor and a memory; the memory is configured to store a computer program, and the processor is configured to invoke and execute the computer program stored in the memory, to cause the network device to perform the method in the above second aspect.

### BRIEF DESCRIPTION OF THE DRAWINGS

FIG. 1 is a schematic diagram of a communication system architecture applied in the embodiments of the present application.

FIG. 2 is a schematic flowchart of a wireless communication method provided according to the embodiments of the present application.

FIG. 3 is a schematic block diagram of a terminal device provided according to the embodiments of the present application.

FIG. 4 is a schematic block diagram of a network device provided according to the embodiments of the present application.

FIG. 5 is a schematic block diagram of a communication device provided according to the embodiments of the present application.

FIG. 6 is a schematic block diagram of an apparatus provided according to the embodiments of the present application.

FIG. 7 is a schematic block diagram of a communication system provided according to the embodiments of the present application.

### DETAILED DESCRIPTION

The technical solutions in the embodiments of the present application will be described in conjunction with the drawings in the embodiments of the present application, and apparently, the described embodiments are a part of the embodiments of the present application, but not all of the embodiments. For the embodiments of the present application, all other embodiments obtained by the ordinary skilled in the art belong to the protection scope of the present application.

The technical solutions of the embodiments of the present application may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolution system of an NR system, an LTE-based access to unlicensed spectrum (LTE-U) system, an NR-based access to unlicensed spectrum (NR-U) system, a Non-Terrestrial communication Network (Non-Terrestrial Networks, NTN) system, a Universal Mobile Telecommunication System (UMTS), a Wireless Local Area Network (WLAN), an internet of things (IoT), a Wireless Fidelity (WiFi), a fifth-generation communication (5th-Generation, 5G) system, a sixth-generation communication (6th-Generation, 6G) system, or other communication systems, etc.

Generally speaking, a number of connections supported by a traditional communication system is limited and is easy to implement, however, with the development of the communication technology, the mobile communication system will not only support the traditional communication, but also support, for example, Device to Device (D2D) communication, Machine to Machine (M2M) communication, Machine Type Communication (MTC), Vehicle to Vehicle (V2V) communication, sidelink (SL) communication, or Vehicle to everything (V2X) communication, etc., and the embodiments of the present application may also be applied to these communication systems.

In some embodiments, the communication system in the embodiments of the present application may be applied to a carrier aggregation (CA) scenario, may also be applied to a dual connectivity (DC) scenario, and may also be applied to a standalone (SA) network deployment scenario, or applied to non-standalone (NSA) network deployment scenario.

In some embodiments, the communication system in the embodiments of the present application may be applied to an unlicensed spectrum, where the unlicensed spectrum may also be considered as a shared spectrum; or the communication system in the embodiments of the present application may also be applied to a licensed spectrum, where the licensed spectrum may also be considered as an unshared spectrum.

In some embodiments, the communication system in the embodiments of the present application may be applied to an FR1 frequency band (corresponding to a frequency band range of 410 MHz to 7.125 GHZ), or may also be applied to an FR2 frequency band (corresponding to a frequency band range of 24.25 GHz to 52.6 GHZ), or may also be applied to a new frequency band, such as a high frequency band corresponding to a frequency band range of 52.6 GHz to 71 GHz or corresponding to a frequency band range of 71 GHz to 114.25 GHZ.

The embodiments of the present application describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent or a user apparatus, etc.

The terminal device may be a station (STATION, STA) in the WLAN, may be a cellular phone, a cordless phone, a Session Initiation Protocol (SIP) phone, a Wireless Local Loop (WLL) station, or a personal digital assistant (PDA) device, a handheld device with a wireless communication function, a computing device or other processing devices connected to a wireless modem, a vehicle-mounted device, a wearable device, a terminal device in a next generation communication system such as in an NR network, or a terminal device in a Public Land Mobile Network (PLMN) network evolved in the future, etc.

In the embodiments of the present application, the terminal device may be deployed on land, which includes indoor or outdoor, in handheld, worn or vehicle-mounted; may also be deployed on water (e.g., on a ship); may also be deployed in the air (e.g., on an airplane, a balloon, a satellite).

In the embodiments of the present application, the terminal device may be a mobile phone, a pad, a computer with a wireless transceiver function, a Virtual Reality (VR) terminal device, an Augmented Reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, a wireless terminal device in smart home, a vehicle-mounted communication device, a wireless communication chip/application specific integrated circuit (ASIC)/system on chip (SoC), etc.

As an example but not a limitation, in the embodiments of the present application, the terminal device may also be a wearable device. The wearable device, which is also referred to as a wearable smart device, is a generic term for a device that can be worn, into which the daily wear is intelligently designed and developed by applying wearable technologies, such as glasses, gloves, watches, clothing, and shoes, etc. The wearable device is a portable device that is worn directly on the body, or integrated into the user's clothing or accessories. The wearable device is not just a hardware device, but also achieves powerful functions through software supporting, data interaction, and cloud interaction. A generalized wearable smart device includes for example, a smartwatch or smart glasses, etc., with full functions, large size, and entire or partial functions without relying on a smartphone, as well as, for example, a smart bracelet and smart jewelry for physical sign monitoring, which only focuses on a certain type of application function and needs to be used in conjunction with other devices such as a smartphone.

In the embodiments of the application, the network device may be a device used for communicating with a mobile device. The network device may be an Access Point (AP) in the WLAN, a base station (Base Transceiver Station, BTS) in the GSM or CDMA, may also be a base station (NodeB, NB) in the WCDMA, or may also be an evolutionary base station (Evolutionary Node B, cNB or eNodeB) in the LTE, or a relay station or an access point, or a vehicle-mounted device, a wearable device, and a network device or a base station (gNB) or a transmission reception point (TRP) in an NR network, or a network device in the PLMN network evolved in the future or a network device in the NTN network, etc.

As an example but not a limitation, in the embodiments of the present application, the network device may have a mobile characteristic, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, etc. In some embodiments, the network device may also be a base station provided on land, water, and other places.

In the embodiments of the present application, the network device may provide a service for a cell, and the terminal device communicates with the network device through a transmission resource (such as a frequency domain resource, or a frequency spectrum resource) used by the cell. The cell may be a cell corresponding to the network device (such as the base station), the cell may belong to a macro base station or may also belong to a base station corresponding to a small cell, and the small cell here may include: a metro cell, a micro cell, a pico cell, a femto cell, etc., these small cells have characteristics of small coverage range and low transmission power, which are applicable for providing a data transmission service with high speed.

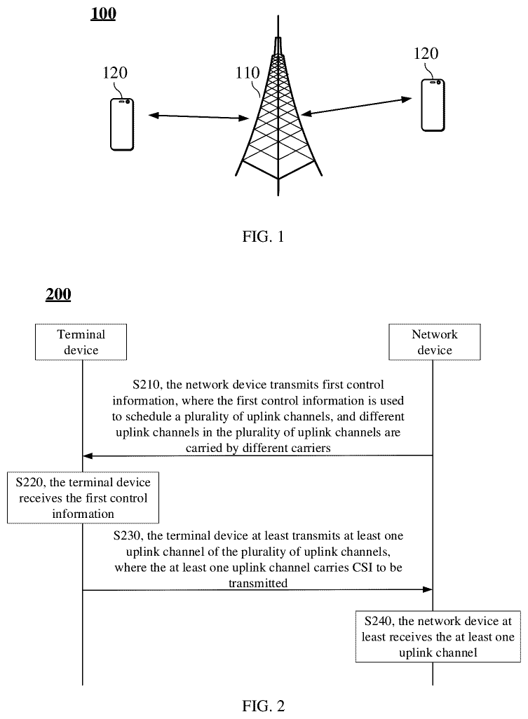

Exemplarily, the communication system 100 applied by the embodiments of the present application is shown in FIG. 1. The communication system 100 may include a network device 110, and the network device 110 may be a device that communicates with a terminal device 120 (also referred to as a communication terminal or a terminal). The network device 110 may provide communication coverage for a specific geographical area and may communicate with a terminal device located within the coverage area.

FIG. 1 exemplarily shows one network device and two terminal devices, and in some embodiments, the communication system 100 may include a plurality of network devices and may include another number of terminal devices within a coverage range of each network device, the embodiments of the present application are not limited thereto.

In some embodiments, the communication system 100 may also include other network entities such as a network controller and a mobility management entity, etc., which are not limited to the embodiments of the present application.

It should be understood that, in the embodiments of the present application, a device with a communication function in the network/system may be referred to as a communication device. Taking the communication system 100 shown in FIG. 1 as an example, the communication device may include the network device 110 and the terminal device 120 with the communication function, and the network device 110 and the terminal device 120 may be the exemplary devices described above, which will not be repeated herein; the communication device may also include other devices in the communication system 100, such as a network controller, a mobility management entity, and other network entities, which are not limited in the embodiments of the present application.

It should be understood that the terms herein “system” and “network” are often used interchangeably herein. The term herein “and/or” is only an association relationship to describe associated objects, meaning that there may be three kinds of relationships, for example, A and/or B may mean three cases where: A exists alone, both A and B exist, and B exists alone. In addition, a character “/” herein generally means that related objects before and after “/” are in an “or” relationship.

It should be understood that the present document relates to a first communication device and a second communication device, and the first communication device may be a terminal device, such as a mobile phone, a machine facility, a customer premise equipment (CPE), an industrial device, a vehicle, etc; the second communication device may be a counterpart communication device of the first communication device, such as a network device, a mobile phone, an industrial device, a vehicle, etc. In the embodiments of the present application, the first communication device may be a terminal device, and the second communication device may be a network device (i.e., an uplink communication or a downlink communication); or, the first communication device may be a first terminal, and the second communication device may be a second terminal (i.e., a sidelink communication).

The terms used in the implementation parts of the present application are only used to explain embodiments of the present application and are not intended to limit the present application. The terms “first”, “second”, “third” and “fourth” etc., in the description, claims and drawings of the present application are used to distinguish different objects rather than to describe a specific order. In addition, the terms “including” and “having” and any derivations thereof are intended to cover non-exclusive inclusion.

It should be understood that the “indication” mentioned in the embodiments of the present application may be a direct indication, may also be an indirect indication, or may also represent having an association relationship. For example, A indicates B, which may mean that A directly indicates B, for example, B may be acquired by A; may also mean that A indirectly indicates B, for example, A indicates C, and B may be acquired by C; or may also mean that there is an association relationship between A and B.

In the description of the embodiments of the present application, the term “correspondence” may mean that there is a direct correspondence or indirect correspondence between the two, it may also mean that there is an associated relationship between the two, or it may also mean a relationship of indicating and being indicated or a relationship of configuring and being configured, etc.

In the embodiments of the present application, “predefined” or “preconfigured” may be implemented by pre-saving corresponding codes, tables or other manners that may be used to indicate related information, in the device (for example, including the terminal device and the network device), and the present application does not limit its specific implementation. For example, the predefined may refer to what is defined in a protocol.

In the embodiments of the present application, the “protocol” may refer to standard protocols in the communication field, for example, which may be an evolution of the existing LTE protocol, NR protocol, Wi-Fi protocol, or other communication system-related protocols related thereto. The present application does not limit the protocol type.

To facilitate the understanding of technical solutions of the embodiments of the present application, the technical solutions of the present application are described in detail below through some embodiments. The following related technologies, as optional solutions, may be randomly combined with the technical solutions of the embodiments of the present application, which all belong to the protection scope of the embodiments of the present application. The embodiments of the present application include at least some of the following contents.

In order to facilitate a better understanding of the embodiments of the present application, CSI reporting based on a PUSCH (CSI reporting using PUSCH) related to the present application is described.

When the terminal device successfully decodes a DCI format 0_1 or DCI format 0_2 for triggering non-periodic CSI, the terminal device should perform non-periodic CSI reporting on a serving cell c by using the PUSCH scheduled by the DCI format 0_1 or DCI format 0_2. When the DCI format 0_1 schedules two PUSCH allocations on the serving cell c, the aperiodic CSI reporting is performed on a second scheduled PUSCH. When the DCI format 0_1 schedules more than two PUSCH allocations on the serving cell c, the aperiodic CSI reporting shall be performed on a second-to-last scheduled PUSCH.

When the terminal device successfully decodes a DCI format 0_1 or DCI format 0_2 for activating semi-persistent CSI, the terminal device should perform the semi-persistent CSI reporting on the PUSCH. The DCI format 0_1 and DCI format 0_2 contain one CSI request field, and the CSI request field indicates a semi-persistent CSI trigger state to be activated or deactivated. The semi-persistent CSI reporting on the PUSCH supports a Type-I, Type-II with a wideband and sub-band frequency granularity, and enhanced Type-II CSI. PUSCH resources and modulation and coding scheme (MCS) should be semi-persistently allocated by uplink DCI.

CSI reporting on the PUSCH may be multiplexed with uplink data on the PUSCH, but semi-persistent CSI reporting on the PUSCH activated by the DCI may not be multiplexed with uplink data on the PUSCH. The CSI reporting on the PUSCH may also be directly transmitted by the PUSCH without being multiplexed with the CSI reporting.

In order to facilitate a better understanding of the embodiments of the present application, problems to be solved related to the present application are explained.

In DC/CA enhancement, a scheme is supported that one DCI schedules the physical downlink shared channels (PDSCHs)/PUSCHs of a plurality of cells.

The CSI reporting based on the PUSCH (CSI reporting using PUSCH) is only applicable to the case where one DCI schedules the PUSCH on one carrier. When introducing that one DCI schedules PUSCHs of the plurality of carriers, how to report CSI is a problem that needs to be solved.

In some embodiments, the “carrier” may also be referred to as a “cell”. In the embodiments of the present application, the cell and the carrier may be interchangeable.

Based on the above problems, the present application proposes a scheme for reporting CSI. In a case where one DCI schedules a plurality of PUSCHs and different PUSCHs of the plurality of PUSCH are carried by different carriers, the PUSCH carrying CSI on one or more carriers may be determined from the plurality of PUSCHs.

In the embodiments, a wireless communication method is provided, which includes:
receiving, by a terminal device, first control information, where the first control information is used to schedule a plurality of uplink channels, and different uplink channels of the plurality of uplink channels are carried by different carriers; and
transmitting at least, by the terminal device, at least one uplink channel of the plurality of uplink channels, where the at least one uplink channel carries channel state information (CSI) to be transmitted.

In some embodiments, the method further includes:
determining, by the terminal device, the at least one uplink channel from the plurality of uplink channels according to first information;
where the first information includes at least one of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

In some embodiments, in a case where the first information at least includes the indication information carried in the first control information, the first control information includes a first information field, where the first information field is used to indicate an identifier of an uplink channel used to carry the CSI in the plurality of uplink channels, or the first information field is used to indicate an identifier of a carrier associated with an uplink channel used to carry the CSI in the plurality of uplink channels;
where the determining, by the terminal device, the at least one uplink channel from the plurality of uplink channels according to the first information, includes:
determining, by the terminal device, the at least one uplink channel from the plurality of uplink channels according to the first information field.

In some embodiments, in the case where the first information field is used to indicate the identifier of the uplink channel used to carry the CSI in the plurality of uplink channels, a correspondence between a value of the first information field and the identifier of the uplink channel is agreed upon by a protocol, or the correspondence between the value of the first information field and the identifier of the uplink channel is configured by a network device through a high layer signaling.

In some embodiments, in the case where the first information field is used to indicate the identifier of the carrier associated with the uplink channel used to carry the CSI in the plurality of uplink channels, a correspondence between a value of the first information field and the identifier of the carrier associated with the uplink channel is agreed upon by a protocol, or the correspondence between the value of the first information field and the identifier of the carrier associated with the uplink channel is configured by a network device through a high layer signaling.

In some embodiments, in a case where the first information at least includes the indication information carried in the first control information, the first control information includes at least one second information field, where the at least one second information field corresponds to the at least one uplink channel respectively, or the at least one second information field corresponds to a carrier associated with the at least one uplink channel respectively;
where the determining, by the terminal device, the at least one uplink channel from the plurality of uplink channels according to the first information, includes:
determining, by the terminal device, the at least one uplink channel from the plurality of uplink channels according to the at least one second information field.

In some embodiments, in a case where the first information at least includes the carrier information associated with the uplink channels, the determining, by the terminal device, the at least one uplink channel from the plurality of uplink channels according to the first information, includes:
selecting, by the terminal device, the at least one uplink channel used to carry the CSI in sequence from the plurality of uplink channels in first order of carrier identifiers associated with the uplink channels.

In some embodiments, in a case where the first information at least includes the scheduling order of the uplink channels in the first control information, the determining, by the terminal device, the at least one uplink channel from the plurality of uplink channels according to the first information, includes:
selecting, by the terminal device, the at least one uplink channel used to carry the CSI in sequence from the plurality of uplink channels in the scheduling order of the uplink channels in the first control information.

In some embodiments, where in a case where the first information at least includes the time domain locations occupied by the uplink channels, the determining, by the terminal device, the at least one uplink channel from the plurality of uplink channels according to the first information, includes:
selecting, by the terminal device, the at least one uplink channel used to carry the CSI in sequence from the plurality of uplink channels in second order of locations of starting symbols occupied by the plurality of uplink channels in time domain.

In some embodiments, in a case where the first information at least includes the preparation time of the CSI to be transmitted, the determining, by the terminal device, the at least one uplink channel from the plurality of uplink channels according to the first information, includes:
selecting, by the terminal device, the at least one uplink channel from an uplink channel for which an interval between a starting symbol of the uplink channel and a last symbol of the first control information is greater than or equal to the preparation time of the CSI to be transmitted, in the plurality of uplink channels.

In some embodiments, in a case where the first information at least includes the number of bits allowed to carry the CSI in the uplink channels, the determining, by the terminal device, the at least one uplink channel from the plurality of uplink channels according to the first information, includes:
selecting, by the terminal device, the at least one uplink channel that meets a transmission requirement of the CSI to be transmitted from the plurality of uplink channels in order from large to small of the number of bits allowed to carry the CSI in the plurality of uplink channels.

In some embodiments, in a case where the first information at least includes the priorities of the uplink channels, the determining, by the terminal device, the at least one uplink channel from the plurality of uplink channels according to the first information, includes:
selecting, by the terminal device, the at least one uplink channel used to carry the CSI in sequence from the plurality of uplink channels in order of priorities of the plurality of uplink channels.

In some embodiments, in a case where the first information at least includes the priorities of the uplink channels and the priority of the CSI, the determining, by the terminal device, the at least one uplink channel from the plurality of uplink channels according to the first information, includes:
selecting, by the terminal device, the at least one uplink channel used to carry the CSI from an uplink channel having a same priority as the priority of the CSI, in the plurality of uplink channels.

In some embodiments, in a case where the first information at least includes the carrier information associated with the uplink channels and the preparation time of the CSI to be transmitted, the determining, by the terminal device, the at least one uplink channel from the plurality of uplink channels according to the first information, includes:
selecting, by the terminal device, the at least one uplink channel in sequence from an uplink channel for which an interval between a starting symbol of the uplink channel and a last symbol of the first control information is greater than or equal to the preparation time of the CSI to be transmitted in the plurality of uplink channels, in first order of carrier identifiers associated with the uplink channels.

In some embodiments, in a case where the first information at least includes the scheduling order of the uplink channels in the first control information and the preparation time of the CSI to be transmitted, the determining, by the terminal device, the at least one uplink channel from the plurality of uplink channels according to the first information, includes:
selecting, by the terminal device, the at least one uplink channel in sequence from an uplink channel for which an interval between a starting symbol of the uplink channel and a last symbol of the first control information is greater than or equal to the preparation time of the CSI to be transmitted in the plurality of uplink channels, in the scheduling order of the uplink channels in the first control information.

In some embodiments, in a case where the first information at least includes the time domain locations occupied by the uplink channels and the preparation time of the CSI to be transmitted, the determining, by the terminal device, the at least one uplink channel from the plurality of uplink channels according to the first information, includes:
selecting, by the terminal device, the at least one uplink channel in sequence from an uplink channel for which an interval between a starting symbol of the uplink channel and a last symbol of the first control information is greater than or equal to the preparation time of the CSI to be transmitted in the plurality of uplink channels, in second order of locations of starting symbols occupied by the plurality of uplink channels in time domain.

In some embodiments, in a case where the first information at least includes the carrier information associated with the uplink channels and the number of bits allowed to carry the CSI in the uplink channels, the determining, by the terminal device, the at least one uplink channel from the plurality of uplink channels according to the first information, includes:
selecting, by the terminal device, the at least one uplink channel that meets a transmission requirement of the CSI to be transmitted from the plurality of uplink channels, in order from large to small of the number of bits allowed to carry the CSI in the plurality of uplink channels and in first order of carrier identifiers associated with the uplink channels.

In some embodiments, in a case where the first information at least includes the scheduling order of the uplink channels in the first control information and the number of bits allowed to carry the CSI in the uplink channels, determining, by the terminal device, the at least one uplink channel from the plurality of uplink channels according to the first information, includes:
selecting, by the terminal device, the at least one uplink channel that meets a transmission requirement of the CSI to be transmitted from the plurality of uplink channels, in order from large to small of the number of bits allowed to carry the CSI in the plurality of uplink channels and in the scheduling order of the uplink channels in the first control information.

In some embodiments, in a case where the first information at least includes the time domain locations occupied by the uplink channels and the number of bits allowed to carry the CSI in the uplink channels, the determining, by the terminal device, the at least one uplink channel from the plurality of uplink channels according to the first information, includes:
selecting, by the terminal device, the at least one uplink channel that meets a transmission requirement of the CSI to be transmitted from the plurality of uplink channels, in order from large to small of the number of bits allowed to carry the CSI in the plurality of uplink channels and in second order of locations of starting symbols occupied by the plurality of uplink channels in time domain.

In some embodiments, in a case where the first information at least includes the number of bits allowed to carry the CSI in the uplink channels and the preparation time of the CSI to be transmitted, the determining, by the terminal device, the at least one uplink channel from the plurality of uplink channels according to the first information, includes:
selecting, by the terminal device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels.

In some embodiments, in a case where the first information at least includes the carrier information associated with the uplink channels, the number of bits allowed to carry the CSI in the uplink channels, and the preparation time of the CSI to be transmitted, the determining, by the terminal device, the at least one uplink channel from the plurality of uplink channels according to the first information, includes:
selecting, by the terminal device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in first order of carrier identifiers associated with the uplink channels.

In some embodiments, in a case where the first information at least includes the scheduling order of the uplink channels in the first control information, the number of bits allowed to carry the CSI in the uplink channels, and the preparation time of the CSI to be transmitted, the determining, by the terminal device, the at least one uplink channel from the plurality of uplink channels according to the first information, includes:
selecting, by the terminal device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in the scheduling order of the uplink channels in the first control information.

In some embodiments, in a case where the first information at least includes the time domain locations occupied by the uplink channels, the number of bits allowed to carry the CSI in the uplink channels, and the preparation time of the CSI to be transmitted, the determining, by the terminal device, the at least one uplink channel from the plurality of uplink channels according to the first information, includes:
selecting, by the terminal device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in second order of locations of starting symbols occupied by the plurality of uplink channels in time domain.

In some embodiments, in a case where the number of bits allowed to carry the CSI in one uplink channel determined from the plurality of uplink channels based on the first information is less than a number of bits of the CSI to be transmitted, a number of the at least one uplink channel is greater than or equal to 2.

In some embodiments, in a case where only one CSI trigger field exists in the first control information, a correspondence between the CSI triggering field and CSI reporting is configured by a network device through a high layer signaling.

In some embodiments, the CSI to be transmitted includes all CSI to be transmitted, or the CSI to be transmitted includes a first part of all CSI to be transmitted.

In some embodiments, the CSI to be transmitted is aperiodic CSI, or the CSI to be transmitted is semi-persistent CSI.

In the embodiments, a wireless communication method is provided, which includes:
transmitting, by a network device, first control information, where the first control information is used to schedule a plurality of uplink channels, and different uplink channels of the plurality of uplink channels are carried by different carriers; and
receiving at least, by the network device, at least one uplink channel of the plurality of uplink channels, where the at least one uplink channel carries channel state information (CSI) to be transmitted.

In some embodiments, the method further includes:
determining, by the network device, the at least one uplink channel from the plurality of uplink channels according to first information;
where the first information includes at least one of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

In some embodiments, in a case where the first information at least includes the indication information carried in the first control information, the first control information includes a first information field, where the first information field is used to indicate an identifier of an uplink channel used to carry the CSI in the plurality of uplink channels, or the first information field is used to indicate an identifier of a carrier associated with an uplink channel used to carry the CSI in the plurality of uplink channels;
where the determining, by the network device, the at least one uplink channel from the plurality of uplink channels according to the first information, includes:
determining, by the network device, the at least one uplink channel from the plurality of uplink channels according to the first information field.

In some embodiments, in the case where the first information field is used to indicate the identifier of the uplink channel used to carry the CSI in the plurality of uplink channels, a correspondence between a value of the first information field and the identifier of the uplink channel is agreed upon by a protocol, or the correspondence between the value of the first information field and the identifier of the uplink channel is configured by a network device through a high layer signaling.

In some embodiments, in the case where the first information field is used to indicate the identifier of the carrier associated with the uplink channel used to carry the CSI in the plurality of uplink channels, a correspondence between a value of the first information field and the identifier of the carrier associated with the uplink channel is agreed upon by a protocol, or the correspondence between the value of the first information field and the identifier of the carrier associated with the uplink channel is configured by a network device through a high layer signaling.

In some embodiments, in a case where the first information at least includes the indication information carried in the first control information, the first control information includes at least one second information field, where the at least one second information field corresponds to the at least one uplink channel respectively, or the at least one second information field corresponds to a carrier associated with the at least one uplink channel respectively;
where the determining, by the network device, the at least one uplink channel from the plurality of uplink channels according to the first information, includes:
determining, by the network device, the at least one uplink channel from the plurality of uplink channels according to the at least one second information field.

In some embodiments, in a case where the first information at least includes the carrier information associated with the uplink channels, the determining, by the network device, the at least one uplink channel from the plurality of uplink channels according to the first information, includes:
selecting, by the network device, the at least one uplink channel used to carry the CSI in sequence from the plurality of uplink channels in first order of carrier identifiers associated with the uplink channels.

In some embodiments, in a case where the first information at least includes the scheduling order of the uplink channels in the first control information, the determining, by the network device, the at least one uplink channel from the plurality of uplink channels according to the first information, includes:
selecting, by the network device, the at least one uplink channel used to carry the CSI in sequence from the plurality of uplink channels in the scheduling order of the uplink channels in the first control information.

In some embodiments, in a case where the first information at least includes the time domain locations occupied by the uplink channels, the determining, by the network device, the at least one uplink channel from the plurality of uplink channels according to the first information, includes:
selecting, by the network device, the at least one uplink channel used to carry the CSI in sequence from the plurality of uplink channels in second order of locations of starting symbols occupied by the plurality of uplink channels in time domain.

In some embodiments, in a case where the first information at least includes the preparation time of the CSI to be transmitted, the determining, by the network device, the at least one uplink channel from the plurality of uplink channels according to the first information, includes:
selecting, by the network device, the at least one uplink channel from an uplink channel for which an interval between a starting symbol of the uplink channel and a last symbol of the first control information is greater than or equal to the preparation time of the CSI to be transmitted, in the plurality of uplink channels.

In some embodiments, in a case where the first information at least includes the number of bits allowed to carry the CSI in the uplink channels, the determining, by the network device, the at least one uplink channel from the plurality of uplink channels according to the first information, includes:
selecting, by the network device, the at least one uplink channel that meets a transmission requirement of the CSI to be transmitted from the plurality of uplink channels in order from large to small of the number of bits allowed to carry the CSI in the plurality of uplink channels.

In some embodiments, in a case where the first information at least includes the priorities of the uplink channels, the determining, by the network device, the at least one uplink channel from the plurality of uplink channels according to the first information, includes:
selecting, by the network device, the at least one uplink channel used to carry the CSI in sequence from the plurality of uplink channels in order of priorities of the plurality of uplink channels.

In some embodiments, in a case where the first information at least includes the priorities of the uplink channels and the priority of the CSI, the determining, by the network device, the at least one uplink channel from the plurality of uplink channels according to the first information, includes:
selecting, by the network device, the at least one uplink channel used to carry the CSI from an uplink channel having a same priority as the priority of the CSI, in the plurality of uplink channels.

In some embodiments, in a case where the first information at least includes the carrier information associated with the uplink channels and the preparation time of the CSI to be transmitted, the determining, by the network device, the at least one uplink channel from the plurality of uplink channels according to the first information, includes:
selecting, by the network device, the at least one uplink channel in sequence from an uplink channel for which an interval between a starting symbol of the uplink channel and a last symbol of the first control information is greater than or equal to the preparation time of the CSI to be transmitted in the plurality of uplink channels, in first order of carrier identifiers associated with the uplink channels.

In some embodiments, in a case where the first information at least includes the scheduling order of the uplink channels in the first control information and the preparation time of the CSI to be transmitted, the determining, by the network device, the at least one uplink channel from the plurality of uplink channels according to the first information, includes:
selecting, by the network device, the at least one uplink channel in sequence from an uplink channel for which an interval between a starting symbol of the uplink channel and a last symbol of the first control information is greater than or equal to the preparation time of the CSI to be transmitted in the plurality of uplink channels, in the scheduling order of the uplink channels in the first control information.

In some embodiments, in a case where the first information at least includes the time domain locations occupied by the uplink channels and the preparation time of the CSI to be transmitted, the determining, by the network device, the at least one uplink channel from the plurality of uplink channels according to the first information, includes:
selecting, by the network device, the at least one uplink channel in sequence from an uplink channel for which an interval between a starting symbol of the uplink channel and a last symbol of the first control information is greater than or equal to the preparation time of the CSI to be transmitted in the plurality of uplink channels, in second order of locations of starting symbols occupied by the plurality of uplink channels in time domain.

In some embodiments, in a case where the first information at least includes the carrier information associated with the uplink channels and the number of bits allowed to carry the CSI in the uplink channels, the determining, by the network device, the at least one uplink channel from the plurality of uplink channels according to the first information, includes:
selecting, by the network device, the at least one uplink channel that meets a transmission requirement of the CSI to be transmitted from the plurality of uplink channels, in order from large to small of the number of bits allowed to carry the CSI in the plurality of uplink channels and in first order of carrier identifiers associated with the uplink channels.

In some embodiments, in a case where the first information at least includes the scheduling order of the uplink channels in the first control information and the number of bits allowed to carry the CSI in the uplink channels, determining, by the network device, the at least one uplink channel from the plurality of uplink channels according to the first information, includes:
selecting, by the network device, the at least one uplink channel that meets a transmission requirement of the CSI to be transmitted from the plurality of uplink channels, in order from large to small of the number of bits allowed to carry the CSI in the plurality of uplink channels and in the scheduling order of the uplink channels in the first control information.

In some embodiments, in a case where the first information at least includes the time domain locations occupied by the uplink channels and the number of bits allowed to carry the CSI in the uplink channels, the determining, by the network device, the at least one uplink channel from the plurality of uplink channels according to the first information, includes:
selecting, by the network device, the at least one uplink channel that meets a transmission requirement of the CSI to be transmitted from the plurality of uplink channels, in order from large to small of the number of bits allowed to carry the CSI in the plurality of uplink channels and in second order of locations of starting symbols occupied by the plurality of uplink channels in time domain.

In some embodiments, in a case where the first information at least includes the number of bits allowed to carry the CSI in the uplink channels and the preparation time of the CSI to be transmitted, the determining, by the network device, the at least one uplink channel from the plurality of uplink channels according to the first information, includes:
selecting, by the network device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels.

In some embodiments, in a case where the first information at least includes the carrier information associated with the uplink channels, the number of bits allowed to carry the CSI in the uplink channels, and the preparation time of the CSI to be transmitted, the determining, by the network device, the at least one uplink channel from the plurality of uplink channels according to the first information, includes:
selecting, by the network device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in first order of carrier identifiers associated with the uplink channels.

In some embodiments, in a case where the first information at least includes the scheduling order of the uplink channels in the first control information, the number of bits allowed to carry the CSI in the uplink channels, and the preparation time of the CSI to be transmitted, the determining, by the network device, the at least one uplink channel from the plurality of uplink channels according to the first information, includes:
selecting, by the network device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in the scheduling order of the uplink channels in the first control information.

In some embodiments, in a case where the first information at least includes the time domain locations occupied by the uplink channels, the number of bits allowed to carry the CSI in the uplink channels, and the preparation time of the CSI to be transmitted, the determining, by the network device, the at least one uplink channel from the plurality of uplink channels according to the first information, includes:
selecting, by the network device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in second order of locations of starting symbols occupied by the plurality of uplink channels in time domain.

In some embodiments, in a case where the number of bits allowed to carry the CSI in one uplink channel determined from the plurality of uplink channels based on the first information is less than a number of bits of the CSI to be transmitted, a number of the at least one uplink channel is greater than or equal to 2.

In some embodiments, in a case where only one CSI trigger field exists in the first control information, a correspondence between the CSI triggering field and CSI reporting is configured by a network device through a high layer signaling.

In some embodiments, the CSI to be transmitted includes all CSI to be transmitted, or the CSI to be transmitted includes a first part of all CSI to be transmitted.

In some embodiments, the CSI to be transmitted is aperiodic CSI, or the CSI to be transmitted is semi-persistent CSI.

The technical solutions of the present application are described in detail below through some embodiments.

FIG. 2 is a schematic flowchart of a wireless communication method 200 according to the embodiments of the present application. As shown in FIG. 2, the wireless communication method 200 may include at least a part of the following content:
S210, transmitting, by a network device, first control information, where the first control information is used to schedule the plurality of uplink channels, and different uplink channels of the plurality of uplink channels are carried by different carriers;
S220, receiving, by a terminal device, the first control information;
S230, transmitting at least, by the terminal device, at least one uplink channel of the plurality of uplink channels, where the at least one uplink channel carries CSI to be transmitted; or
S240, receiving at least, by the network device, the at least one uplink channel.

In the embodiments of the present application, the terminal device supports to transmit multi-carrier uplink channels, that is, the terminal device has the ability to transmit uplink channels on multiple carriers.

In some embodiments, the first control information is used to schedule the plurality of uplink channels, which includes that an uplink grant carried in the first control information is used to schedule the plurality of uplink channels.

In some embodiments, the at least one uplink channel may be one uplink channel, or may be a plurality of uplink channels or at least two uplink channels (e.g., two or more uplink channels).

In some embodiments, the terminal device may also transmit a part or all of other uplink channels other than the at least one uplink channel in the plurality of uplink channels. For example, the terminal device may transmit a part or all of other uplink channels other than the at least one uplink channel in the plurality of uplink channels based on a channel quality and/or carrier characteristic. In some implementations, the other uplink channels other than the at least one uplink channel in the plurality of uplink channels carry uplink data, and the CSI is not transmitted on the other uplink channels other than the at least one uplink channel in the plurality of uplink channels.

In some embodiments, the CSI to be transmitted described in the embodiments of the present application is aperiodic CSI or semi-persistent CSI. In some embodiments, for the semi-persistent CSI, the selected uplink channel is not used to transmit data any more, that is, only used to transmit the semi-persistent CSI; for the aperiodic CSI, the selected uplink channel may also be used to transmit uplink data, that is, the CSI reporting on the uplink channel may be multiplexed with the uplink data on the uplink channel.

In some embodiments, the CSI to be transmitted includes all CSI to be transmitted, or the CSI to be transmitted includes a first part (CSI part 1) of all CSI to be transmitted.

It should be noted that the CSI includes two parts: a CSI part 1 and a CSI part 2. A payload size of the CSI part 1 is fixed and is used to confirm information bits of the CSI part 2. Therefore, the CSI part 1 is always transmitted before the CSI part 2. For example, when the CSI part 1 is transmitted together with an uplink shared channel (UL-SCH) on the PUSCH, in each layer, the number of symbols after the CSI-part 1 is modulated is also the number of symbols occupied by the CSI Part 1; when the CSI part 2 is transmitted together with the UL-SCH on the PUSCH, in each layer, the number of symbols after the CSI-part 2 is modulated is also the number of resource elements (REs) occupied by the CSI-Part 2.

In some embodiments, the uplink channel described in the embodiments of the present application is the PUSCH. Of course, the uplink channel described in the embodiments of the present application may also be other uplink channels, which is not limited to the present application.

In some embodiments, the first control information described in the embodiments of the present application is DCI. Of course, the first control information described in the embodiments of the present application may also be other control information, which is not limited to the present application. In some embodiments, the first control information is the DCI format 0_1, or the first control information is the DCI format 0_2, or the first control information is the DCI format 0_3.

In some implementations, the first control information is DCI, and the first uplink channel is a PUSCH. In some embodiments, the terminal device receives the DCI, and the DCI carries an uplink grant. For example, the DCI is the DCI format 0_1, DCI format 0_2, or DCI format 0_3. The uplink grant is used to schedule at least two uplink shared physical channels (PUSCHs), and each PUSCH is carried by one carrier. For example, the uplink grant schedules a PUSCH on one carrier 1 and a PUSCH on one carrier 2.

In some embodiments, the first control information may be, for example, DCI format 0_1 or DCI format 0_2 or DCI format 0_3. The first control information includes an information field (i.e., a CSI trigger field) for triggering the CSI reporting. For example, the CSI trigger field is a CSI request field. When the CSI trigger field triggers one aperiodic CSI reporting, the terminal device selects at least one PUSCH carrier according to a reporting content indicated by the CSI trigger field. For example, when a value of the CSI request field is 1, the CSI reporting content is determined according to one aperiodic CSI trigger state (CSI-Aperiodic TriggerState) associated with CSI request=1. For example, at least one of the following measured based on a non-zero power channel state information reference signal (Non-Zero Power Channel State Information-Reference Signal, NZP-CSI-RS) is reported: a CSI-RS resource indicator (CRI), rank indication (RI), precoding matrix indicator (PMI), or channel quantity indicator (CQI).

In some embodiments, in a case where there is only one CSI trigger field in the first control information, a correspondence between the CSI trigger field and the CSI reporting is configured by a network device through a high layer signaling.

In some embodiments, the terminal device determines the at least one uplink channel from the plurality of uplink channels according to the first information, and/or the network device determines the at least one uplink channel from the plurality of uplink channels according to the first information.

In some implementations, the first information includes, but is not limited to, at least one of the following: carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

In some implementations, the preparation time of the CSI to be transmitted may be understood as the time or duration required to prepare the CSI to be transmitted.

In some implementations, the carrier information associated with the uplink channels may be carrier identifiers associated with the uplink channel, or the carrier information associated with the uplink channels may be carrier indices associated with the uplink channels, or the carrier information associated with the uplink channels may be carrier numbers associated with the uplink channels.

In some implementations, the number of bits allowed to carry the CSI in the uplink channels may be obtained according to resources that carry the CSI in the uplink channels.

In some implementations, the first uplink channel is the PUSCH. In some embodiments, if no acknowledgement (ACK)/negative acknowledgement (NACK) is multiplexed into the PUSCH, the resources carrying the CSI in the uplink channel are resources carrying uplink control information (UCI) in the uplink channel. If the ACK/NACK is multiplexed into the PUSCH, the resources carrying the CSI in the uplink channel are resources obtained by removing resources occupied by the ACK/NACK from the resources carrying the UCI in the uplink channel. The resources carrying the UCI in the uplink channel are determined by a network configuration. The number of bits for carrying the CSI in the uplink channel is determined according to the number of resources carrying the CSI in the uplink channel and modulation coding of the CSI.

In some implementations, in a case where the number of bits allowed to carry the CSI in one uplink channel determined from the plurality of uplink channels based on the first information is less than the number of bits of the CSI to be transmitted, the number of the at least one uplink channel is greater than or equal to 2, that is, one or more uplink channels used to carry the CSI may be determined from the plurality of uplink channels based on the first information.

### Implementation 1

The at least one uplink channel may be determined from the plurality of uplink channels based on one of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

In some embodiments, the at least one uplink channel may be determined from the plurality of uplink channels based on the indication information carried in the first control information. In some embodiments, the first control information includes a first information field, the first information field is used to indicate an identifier of an uplink channel used to carry the CSI in the plurality of uplink channels, or the first information field is used to indicate an identifier of a carrier associated with an uplink channel used to carry the CSI in the plurality of uplink channels. That is, the indication information carried in the first control information is the first information field.

In some embodiments, the terminal device may determine the at least one uplink channel from the plurality of uplink channels according to the first information field, or the network device may determine the at least one uplink channel from the plurality of uplink channels according to the first information field.

In this embodiment, by adding a new information field in the first control information, the at least one uplink channel may be determined from the plurality of uplink channels based on the new information field, or an existing information field in the first control information may be multiplexed, and the at least one uplink channel may be determined from the plurality of uplink channels based on the existing information field, by which the operation is simple and easy to implement.

In some implementations, the first control information is the DCI format 0_1 or DCI format 0_2 or DCI format 0_3. For example, the first information field in the first control information is a CSI carrier indicator (carrier indicator for CSI) or a CSI PUSCH indicator (PUSCH indicator for CSI).

In some examples, in the case where the first information field is used to indicate the identifier of the uplink channel used to carry the CSI in the plurality of uplink channels, a correspondence between a value of the first information field and the identifier of the uplink channel is agreed upon by a protocol, or the correspondence between the value of the first information field and the identifier of the uplink channel is configured by a network device through a high layer signaling.

In some examples, the first control information is DCI, and the first uplink channel is the PUSCH. In some embodiments, the first information field is the CSI carrier indicator (carrier indicator for CSI). When the carrier indicator for CSI indicates x, it indicates that the PUSCH of the carrier corresponding to x multiplexes the CSI (that is, the PUSCH of the carrier corresponding to x allows the transmission of the CSI), where a correspondence between x and the carrier may be configured by the network device through the high layer signaling, or the correspondence between x and the carrier may be agreed upon by the protocol. For example, the x order is consistent with the carrier order determined by the carrier indication field, taking an example in which x is numbered starting from 0, then x=0 indicates a first carrier in a carrier combination indicated by the carrier indication field; x=1 indicates a second carrier in the carrier combination indicated by the carrier indication field; and so on. If x is numbered starting from 1, then x=1 indicates a first carrier in a carrier combination indicated by the carrier indication field; x=2 indicates a second carrier in the carrier combination indicated by the carrier indication field; and so on.

In some examples, the first control information is DCI, and the first information field carried in the first control information is the CSI carrier indicator (carrier indicator for CSI). In some embodiments, the first control information may be as follows:

{
- Frequency domain resource assignment
- Time domain resource assignment
- CSI request
......
- Frequency domain resource assignment
- Time domain resource assignment
......
- carrier indicator for CSI
......
}

In some examples, in the case where the first information field is used to indicate the identifier of the carrier associated with the uplink channel used to carry the CSI in the plurality of uplink channels, a correspondence between a value of the first information field and the identifier of the carrier associated with the uplink channel is agreed upon by a protocol, or the correspondence between the value of the first information field and the identifier of the carrier associated with the uplink channel is configured by a network device through a high layer signaling.

In some examples, the first control information is DCI, and the first uplink channel is the PUSCH. In some embodiments, the first information field is the CSI PUSCH indicator (PUSCH indicator for CSI). In a case where the PUSCH indicator for CSI indicates y, it indicates a PUSCH corresponding to y in the plurality of PUSCH scheduled by the first control information. A correspondence between y and the PUSCH may be configured by the network device through the high layer signaling, or the correspondence between y and the PUSCH may be agreed upon by the protocol. For example, the y order is consistent with the order of information for scheduling the PUSCH in the first control information. In some embodiments, the first control information may include N parts, each part corresponds to one PUSCH, and N is an integer greater than or equal to 2. Taking N=2 as an example, a first part (the first M bits) contains scheduling information of a first PUSCH, and a second part ((M+1)-th and subsequent bits) contains scheduling information of a second PUSCH.

In some examples, the first control information is DCI, and the first information field carried in the first control information is the CSI PUSCH indicator (PUSCH indicator for CSI). In some embodiments, the first control information may be as follows:

{
- Frequency domain resource assignment
- Time domain resource assignment
- CSI request
......
- Frequency domain resource assignment
- Time domain resource assignment
......
- PUSCH indicator for CSI
......
}

In some examples, one parameter included in the first information is the indication information carried in the first control information. In some embodiments, the first control information includes at least one second information field, where the at least one second information field corresponds to the at least one uplink channel respectively, or the at least one second information field corresponds to a carrier associated with the at least one uplink channel respectively. That is, the indication information carried in the first control information is the at least one second information field. In some embodiments, for example, the second information field is a CSI request indication field.

In some embodiments, the terminal device may determine the at least one uplink channel from the plurality of uplink channels according to the at least one second information field, or the network device may determine the at least one uplink channel from the plurality of uplink channels according to the at least one second information field.

In this example, by adding at least one information field in the first control information, the at least one uplink channel may be determined from the plurality of uplink channels based on the at least one information field, and the uplink channel may be determined more finely, by which the operation is simple and easy to implement.

In some examples, the first control information is DCI, the first uplink channel is the PUSCH, and the second information field is the CSI request indication field. In some embodiments, there are N CSI request indication fields, where N is a positive integer, and 1<N<=M, M is the number of PUSCHs scheduled by the uplink grant carried in one piece of first control information, M is a positive integer, and M PUSCHs are respectively carried by M carriers. The N CSI requests correspond to N PUSCHs, and this correspondence is agreed upon by the protocol. For example, the N CSI requests correspond to the first N PUSCHs scheduled by the uplink grant, or the PUSCHs corresponding to the N CSI requests are configured by a high layer, for example, the high layer signaling configures identifiers of the N PUSCHs or identifiers of N carriers in the uplink grant corresponding to the N CSI requests.

In some examples, the first control information is DCI, and the second information field carried in the first control information is the CSI request indication field. In some embodiments, the first control information may be as follows:

{
- Frequency domain resource assignment
- Time domain resource assignment
- CSI request
......
- Frequency domain resource assignment
- Time domain resource assignment
- CSI request
......
- Frequency domain resource assignment
- Time domain resource assignment
......
}

In some examples, the at least one uplink channel may be determined from the plurality of uplink channels based on the carrier information associated with the uplink channels. The carrier information associated with the uplink channels is, for example, carrier identifiers associated with the uplink channels. In some embodiments, the at least one uplink channel used to carry the CSI may be selected in sequence from the plurality of uplink channels in first order of the carrier identifiers associated with the uplink channels. The first order may be from small to large, or the first order may be from large to small. Of course, the first order may also be other order, such as order of even-numbered bits from small to large, or order of odd-numbered bits from small to large, which is not limited to the present application.

In this example, the at least one uplink channel may be determined from the plurality of uplink channels based on the carrier information associated with the uplink channels, by which the operation is simple, no additional signaling overhead is required, and it is easy to implement.

In some examples, in a case where the number of bits allowed to carry the CSI in one uplink channel determined from the plurality of uplink channels based on the carrier information associated with the uplink channels is less than a number of bits of the CSI to be transmitted, the number of the at least one uplink channel is greater than or equal to 2. That is, at least two uplink channels used to carry the CSI may be selected in sequence from the plurality of uplink channels in order from small to large of the carrier identifiers associated with the uplink channels, or the at least two uplink channels used to carry the CSI may be selected in sequence from the plurality of uplink channels in order from large to small of the carrier identifiers associated with the uplink channels.

In some examples, the first control information schedules PUSCHs on the carrier 1 and carrier 2, and triggers the CSI reporting, and the CSI to be transmitted is multiplexed in the PUSCH on the carrier 1. That is, the PUSCH corresponding to the smallest carrier identifier carries the CSI.

In some examples, the first control information schedules PUSCHs on the carrier 1 and carrier 2, and triggers the CSI reporting, and the CSI to be transmitted is multiplexed in the PUSCH on the carrier 2. That is, the PUSCH corresponding to the largest carrier identifier carries the CSI.

In some examples, the first control information schedules PUSCHs on the carrier 1, carrier 2, and carrier 3, and triggers the CSI reporting. The CSI to be transmitted is first multiplexed in the PUSCH on the carrier 1. In a case where the CSI to be transmitted cannot be fully carried in the PUSCH on the carrier 1, the remaining CSI of the CSI to be transmitted is then multiplexed in the PUSCH on the carrier 2, and so on, until the CSI to be transmitted is completely transmitted. That is, the at least one PUSCH used to carry the CSI may be selected in sequence from the plurality of PUSCHs in order from small to large of the carrier identifiers associated with the PUSCHs.

In some examples, the first control information schedules PUSCHs on the carrier 1, carrier 2 and carrier 3, and triggers the CSI reporting. The CSI to be transmitted is first multiplexed in the PUSCH on the carrier 3. In a case where the CSI to be transmitted cannot be fully carried in the PUSCH on the carrier 3, the remaining CSI of the CSI to be transmitted is then multiplexed in the PUSCH on the carrier 2, and so on, until the CSI to be transmitted is completely transmitted. That is, the at least one PUSCH used to carry the CSI may be selected in sequence from the plurality of PUSCH in order from large to small of the carrier identifiers associated with the PUSCHs.

In some examples, the at least one uplink channel may be determined from the plurality of uplink channels based on the scheduling order of the uplink channels in the first control information. In some embodiments, the at least one uplink channel used to carry the CSI may be selected in sequence from the plurality of uplink channels in the scheduling order of the uplink channels from front to back in the first control information, or the at least one uplink channel used to carry the CSI may be selected in sequence from the plurality of uplink channels according to the scheduling order of the uplink channels from back to front in the first control information.

In this example, the at least one uplink channel may be determined from the plurality of uplink channels based on the scheduling order of the uplink channels in the first control information, by which the operation is simple, no additional signaling overhead is required, and it is easy to implement.

In some examples, in a case where the number of bits allowed to carry the CSI in one uplink channel determined from the plurality of uplink channels based on the scheduling order of the uplink channels in the first control information is less than the number of bits of the CSI to be transmitted, the number of the at least one uplink channel is greater than or equal to 2. That is, at least two uplink channels used to carry the CSI may be selected in sequence from the plurality of uplink channels in the scheduling order of the uplink channels from front to back in the first control information, or the at least two uplink channels used to carry the CSI may be selected in sequence from the plurality of uplink channels in the scheduling order of the uplink channels from back to front in the first control information.

In some examples, the first control information schedules a PUSCH 1 and PUSCH 2, where the scheduling order of PUSCHs in the first control information is the PUSCH 1, and the PUSCH 2 in sequence, and the CSI reporting is triggered, then the CSI to be transmitted is multiplexed in the PUSCH 1. That is, the PUSCH corresponding to the first one of the scheduling order carries the CSI.

In some examples, the first control information schedules a PUSCH 1 and PUSCH 2, where the scheduling order of PUSCHs in the first control information is PUSCH 1, and PUSCH 2 in sequence, and the CSI reporting is triggered, then the CSI to be transmitted is multiplexed in the PUSCH 2. That is, the PUSCH corresponding to the last one of the scheduling order carries the CSI.

In some examples, the first control information schedules a PUSCH 1, PUSCH 2 and PUSCH 3, where the scheduling order of PUSCHs in the first control information is PUSCH 1, PUSCH 2 and PUSCH 3 in sequence, and the CSI reporting is triggered, and the CSI to be transmitted is first multiplexed in the PUSCH 1. In a case where the CSI to be transmitted cannot be fully carried in the PUSCH 1, the remaining CSI of the CSI to be transmitted is then multiplexed in the PUSCH 2, and so on, until the CSI to be transmitted is completely transmitted. That is, the at least one PUSCH used to carry the CSI may be selected in sequence from the plurality of PUSCHs in order of the scheduling order from front to back of the PUSCHs in the first control information.

In some examples, the first control information schedules a PUSCH 1, PUSCH 2 and PUSCH 3, where the scheduling order of PUSCHs in the first control information is PUSCH 1, PUSCH 2 and PUSCH 3 in sequence, and the CSI reporting is triggered, and the CSI to be transmitted is first multiplexed in the PUSCH 3. In a case where the CSI to be transmitted cannot be fully carried in the PUSCH 3, the remaining CSI of the CSI to be transmitted is then multiplexed in the PUSCH 2, and so on, until the CSI to be transmitted is completely transmitted. That is, the at least one PUSCH used to carry the CSI may be selected in sequence from the plurality of PUSCHs in order of the scheduling order from back to front of the PUSCHs in the first control information.

In some examples, the at least one uplink channel may be determined from the plurality of uplink channels based on the time domain locations occupied by the uplink channels. The time domain locations occupied by the uplink channels are, for example, locations of starting symbols occupied by the uplink channels in time domain. In some embodiments, the at least one uplink channel used to carry the CSI may be selected in sequence from the plurality of uplink channels in second order of locations of the starting symbols occupied by the plurality of uplink channels in time domain. The second order may be order from front to back, or the second order may be order from back to front. Of course, the second order may also be other order, which is not limited to the embodiments of the present application.

In this example, the at least one uplink channel may be determined from the plurality of uplink channels based on the time domain locations occupied by the uplink channels, by which the operation is simple, no additional signaling overhead is required, and it is easy to implement.

In some examples, in a case where the number of bits allowed to carry the CSI in one uplink channel determined from the plurality of uplink channels based on the time domain locations occupied by the uplink channels is less than the number of bits of the CSI to be transmitted, the number of the at least one uplink channel is greater than or equal to 2. That is, at least two uplink channels used to carry the CSI may be selected in sequence from the plurality of uplink channels in order from front to back of the locations of the starting symbols occupied by the plurality of uplink channels in time domain, or at least two uplink channels used to carry the CSI may be selected in sequence from the plurality of uplink channels in order from back to front of the locations of the starting symbols occupied by the plurality of uplink channels in time domain.

In some examples, the first control information schedules a PUSCH 1 and PUSCH 2, where the order from front to back of starting symbols of the PUSCH 1 and PUSCH 2 in time domain is the PUSCH 1 and the PUSCH 2 in sequence, and the CSI reporting is triggered, then the CSI to be transmitted is multiplexed in the PUSCH 1. That is, the PUSCH corresponding to the frontmost starting symbol location carries the CSI.

In some examples, the first control information schedules a PUSCH 1 and PUSCH 2, where the order from front to back of locations of starting symbols occupied by the PUSCH 1 and PUSCH 2 in time domain are PUSCH 1 and PUSCH 2 in sequence, and the CSI reporting is triggered, then the CSI to be transmitted is multiplexed in the PUSCH 2. That is, the PUSCH corresponding to the last starting symbol location carries the CSI.

In some examples, the first control information schedules a PUSCH 1, PUSCH 2, and PUSCH 3, where the order from front to back of locations of starting symbols occupied by the PUSCH 1, PUSCH 2, and PUSCH 3 in time domain are PUSCH 1, PUSCH 2, and PUSCH 3 in sequence, and the CSI reporting is triggered, and the CSI to be transmitted is first multiplexed in the PUSCH 1. In a case where the CSI to be transmitted cannot be fully carried in the PUSCH 1, the remaining CSI of the CSI to be transmitted is then multiplexed in the PUSCH 2, and so on, until the CSI to be transmitted is completely transmitted. That is, the at least one PUSCH used to carry the CSI may be selected from the plurality of PUSCH in sequence in the order from front to back of the locations of the starting symbols occupied by the plurality of uplink channels in time domain.

In some examples, the first control information schedules a PUSCH 1, PUSCH 2, and PUSCH 3, where the order from back to front of locations of starting symbols occupied by the PUSCH 1, PUSCH 2, and PUSCH 3 in time domain are PUSCH 1, PUSCH 2, and PUSCH 3 in sequence, and the CSI reporting is triggered, and the CSI to be transmitted is first multiplexed in the PUSCH 3. In a case where the CSI to be transmitted cannot be fully carried in the PUSCH 3, the remaining CSI of the CSI to be transmitted is then multiplexed in the PUSCH 2, and so on, until the CSI to be transmitted is completely transmitted. That is, the at least one PUSCH used to carry the CSI may be selected from the plurality of PUSCH in sequence in the order from back to front of the locations of the starting symbols occupied by the plurality of uplink channels in time domain.

In some examples, the at least one uplink channel may be determined from the plurality of uplink channels based on the preparation time of the CSI to be transmitted. In some embodiments, the at least one uplink channel used to carry the CSI may be selected from an uplink channel for which an interval between a starting symbol of the uplink channel and a last symbol of the first control information is greater than or equal to the preparation time of the CSI to be transmitted, in the plurality of uplink channels.

In this example, the at least one uplink channel may be determined from the plurality of uplink channels based on the preparation time of the CSI to be transmitted, by which the operation is simple, no additional signaling overhead is required, and it is easy to implement.

In some examples, in a case where the number of bits allowed to carry the CSI in one uplink channel determined from the plurality of uplink channels based on the preparation time of the CSI to be transmitted is less than the number of bits of the CSI to be transmitted, the number of the at least one uplink channel is greater than or equal to 2. That is, the at least two uplink channels used to carry the CSI may be selected from the plurality of uplink channels according to the preparation time of the CSI to be transmitted.

In some examples, the first control information schedules a PUSCH 1 and PUSCH 2, and an interval between a starting symbol location occupied by the PUSCH 1 in time domain and the last symbol of the first control information is less than the CSI preparation time, but an interval between a starting symbol location occupied by the PUSCH 2 in time domain and the last symbol of the first control information is greater than or equal to the CSI preparation time, and the CSI reporting is triggered, then the CSI is multiplexed in the PUSCH 2.

In some examples, the first control information schedules a PUSCH 1 and PUSCH 2, where an interval between a starting symbol location occupied by the PUSCH 1 in time domain and the last symbol of the first control information is greater than or equal to the CSI preparation time, and an interval between a starting symbol location occupied by the PUSCH 2 in time domain and the last symbol of the first control information is greater than or equal to the CSI preparation time, and the CSI reporting is triggered, then the CSI is multiplexed in the PUSCH 1 or the PUSCH 2.

In some examples, the first control information schedules a PUSCH 1 and PUSCH 2, where an interval between a starting symbol location occupied by the PUSCH 1 in time domain and the last symbol of the first control information is greater than or equal to the CSI preparation time, and an interval between a starting symbol location occupied by the PUSCH 2 in time domain and the last symbol of the first control information is greater than or equal to the CSI preparation time, and the CSI reporting is triggered. The CSI to be transmitted may be multiplexed in the PUSCH 1 first, and in a case where the CSI to be transmitted cannot be fully carried in the PUSCH 1, the remaining CSI of the CSI to be transmitted is then multiplexed in the PUSCH 2, and so on, until the CSI to be transmitted is completely transmitted.

In some examples, the at least one uplink channel may be determined from the plurality of uplink channels based on the number of bits allowed to carry the CSI in the uplink channels. In some embodiments, the at least one uplink channel that meets a transmission requirement of the CSI to be transmitted may be selected from the plurality of uplink channels in order from large to small of the number of bits allowed to carry the CSI in the plurality of uplink channels.

In this example, the at least one uplink channel may be determined from the plurality of uplink channels based on the order from large to small of the number of bits allowed to carry the CSI in the uplink channels, by which the operation is simple, no additional signaling overhead is required, and it is easy to implement.

In some examples, in a case where the number of bits allowed to carry the CSI in one uplink channel determined from the plurality of uplink channels based on the number of bits allowed to carry the CSI in the uplink channels is less than the number of bits of the CSI to be transmitted, the number of the at least one uplink channel is greater than or equal to 2. That is, the at least two uplink channels used to carry the CSI may be selected from the plurality of uplink channels according to the number of bits allowed to carry the CSI in the uplink channels.

In some examples, a frontmost PUSCH that meets the transmission requirement of the CSI to be transmitted in the PUSCHs scheduled by the first control information carries the CSI. In some embodiments, for example, the first control information schedules a PUSCH 1 and PUSCH 2, and the number of bits allowed to carry the CSI in the PUSCH 1 is N1, and the number of bits allowed to carry the CSI in the PUSCH 2 is N2. Assuming that the number of bits of the CSI to be transmitted is N, if N1>N, and N2>N, the frontmost PUSCH that meets the preparation time of the CSI is selected from the PUSCH 1 and PUSCH 2, and the CSI is multiplexed in the selected PUSCH. Assuming that the number of bits of the CSI to be transmitted is N, if N1>N but N2<N, the CSI is multiplexed in the PUSCH 1, where the interval between the starting symbol of the PUSCH 1 and the last symbol of the first control information is not less than the preparation time of the CSI.

In some examples, the at least one uplink channel may be determined from the plurality of uplink channels based on the priorities of the uplink channels. In some embodiments, the at least one uplink channel used to carry the CSI may be selected in sequence from the plurality of uplink channels in the order of priorities of the plurality of uplink channels. The order of the priorities may be order from high to low, or the order of the priorities may be order from low to high.

In this example, the at least one uplink channel may be determined from the plurality of uplink channels based on the priorities of the uplink channels, by which, the operation is simple, no additional signaling overhead is required, and it is easy to implement.

In some examples, in a case where the number of bits allowed to carry the CSI in one uplink channel determined from the plurality of uplink channels based on the priorities of the uplink channels is less than the number of bits of the CSI to be transmitted, the number of the at least one uplink channel is greater than or equal to 2. That is, at least two uplink channels used to carry the CSI may be selected from the plurality of uplink channels according to the priorities of the uplink channels.

In some examples, the first control information schedules a PUSCH 1 and PUSCH 2, and the priority of the PUSCH 1 is a high priority and the priority of the PUSCH 2 is a low priority, or the priority of the PUSCH 1 is higher than the priority of the PUSCH 2, and the CSI reporting is triggered, then the CSI is multiplexed in the PUSCH 1. That is, the PUSCH corresponding to the highest priority carries the CSI.

In some examples, the first control information schedules a PUSCH 1 and PUSCH 2, and the priority of the PUSCH 1 is a high priority and the priority of the PUSCH 2 is a low priority, or the priority of the PUSCH 1 is higher than the priority of the PUSCH 2, and the CSI reporting is triggered, then the CSI is multiplexed in the PUSCH 2. That is, the PUSCH corresponding to the lowest priority carries the CSI.

In some examples, the first control information schedules a PUSCH 1, PUSCH 2 and PUSCH 3, where the order from high to low of the priorities of the PUSCH 1, PUSCH 2 and PUSCH 3 is the PUSCH 1, the PUSCH 2 and the PUSCH 3 in sequence, and the CSI reporting is triggered. The CSI to be transmitted may be multiplexed in the PUSCH 1 first. In a case where the CSI to be transmitted cannot be fully carried in the PUSCH 1, the remaining CSI of the CSI to be transmitted is then multiplexed in the PUSCH 2, and so on, until the CSI to be transmitted is completely transmitted. That is, the at least one PUSCH used to carry the CSI may be selected in sequence from the plurality of uplink channels in the order from high to low of the priorities of the plurality of uplink channels.

In some examples, the first control information schedules a PUSCH 1, PUSCH 2 and PUSCH 3, where the order from low to high of the priorities of the PUSCH 1, PUSCH 2 and PUSCH 3 is the PUSCH 1, the PUSCH 2 and the PUSCH 3 in sequence, and the CSI reporting is triggered. The CSI to be transmitted may be multiplexed in the PUSCH 3 first. In a case where the CSI to be transmitted cannot be fully carried in the PUSCH 3, the remaining CSI of the CSI to be transmitted is then multiplexed in the PUSCH 2, and so on, until the CSI to be transmitted is completely transmitted. That is, the at least one PUSCH used to carry the CSI may be selected in sequence from the plurality of uplink channels in the order from low to high of the priorities of the plurality of uplink channels.

### Implementation 2

The at least one uplink channel may be determined from the plurality of uplink channels based on two of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

In some examples, the at least one uplink channel may be determined from the plurality of uplink channels based on the priorities of the uplink channels and the priority of the CSI. In some embodiments, the at least one uplink channel used to carry the CSI may be selected from an uplink channel having a same priority as the priority of the CSI, in the plurality of uplink channels.

In this implementation example, the at least one uplink channel may be determined from the plurality of uplink channels based on the priorities of the uplink channels and the priority of the CSI, by which the operation is simple, no additional signaling overhead is required, and it is easy to implement.

In some examples, in a case where the number of bits allowed to carry the CSI in one uplink channel determined from the plurality of uplink channels based on the priorities of the uplink channels and the priority of CSI is less than the number of bits of the CSI to be transmitted, the number of the at least one uplink channel is greater than or equal to 2. That is, at least two uplink channels used to carry the CSI may be selected from the plurality of uplink channels according to the priorities of the uplink channels and the priority of the CSI.

In some examples, the first control information schedules a PUSCH 1 and PUSCH 2, and the priority of the PUSCH 1 is a high priority and the priority of the PUSCH 2 is a low priority, or the priority of the PUSCH 1 is higher than the priority of the PUSCH 2, the priority of the PUSCH 1 is the same as the priority of the CSI to be transmitted, and the CSI reporting is triggered, then the CSI is multiplexed in the PUSCH 1.

In some examples, the first control information schedules a PUSCH 1 and PUSCH 2, and the priority of the PUSCH 1 is a high priority and the priority of the PUSCH 2 is a low priority, or the priority of the PUSCH 1 is higher than the priority of the PUSCH 2, the priority of the PUSCH 2 is the same as the priority of the CSI to be transmitted, and the CSI reporting is triggered, then the CSI is multiplexed in the PUSCH 2.

In some examples, a PUSCH with the same priority as the priority of the CSI in the PUSCHs scheduled by the first control information carries the CSI. In some embodiments, for example, the first control information schedules a PUSCH 1 and PUSCH 2, where the priority of the PUSCH 1 is a high priority and the priority of the PUSCH 2 is a low priority. A PUSCH with the matched priority may be selected according to the priority of the CSI to be transmitted. In a case where the CSI to be transmitted has no priority corresponding to the explicit configuration, the CSI is multiplexed in the PUSCH 2 with the low priority. In a case where the CSI is explicitly configured with a priority, the CSI is multiplexed in the PUSCH with the same priority as the CSI. In some embodiments, for example, the CSI is configured as the high priority, then the CSI is multiplexed in the PUSCH 1 with the high priority; the CSI is configured as the low priority, then the CSI is multiplexed in the PUSCH 2 with the low priority.

Optionally, in Implementation 2, the at least one uplink channel may be determined from the plurality of uplink channels based at least on the preparation time of the CSI to be transmitted or the number of bits allowed to carry the CSI in the uplink channels.

In some examples, the at least one uplink channel may be determined from the plurality of uplink channels based on the carrier information associated with the uplink channels and the preparation time of the CSI to be transmitted. The carrier information associated with the uplink channels may be, for example, carrier identifiers. In some embodiments, the at least one uplink channel may be selected in sequence from an uplink channel for which an interval between a starting symbol of the uplink channel and a last symbol of the first control information is greater than or equal to the preparation time of the CSI to be transmitted in the plurality of uplink channels, in first order of carrier identifiers associated with the uplink channels. The first order may be order from small to large, or the first order may be order from large to small. Of course, the first order may also be other order, such as order of even-numbered bits from small to large, or order of odd-numbered bits from small to large, which is not limited to the present application.

In this example, the at least one uplink channel may be determined from the plurality of uplink channels based on the carrier information associated with the uplink channels and the preparation time of the CSI to be transmitted, by which the operation is simple, no additional signaling overhead is required, and it is easy to implement.

In some examples, in a case where the number of bits allowed to carry the CSI in one uplink channel determined from the plurality of uplink channels based on the carrier information associated with the uplink channels and the preparation time of the CSI to be transmitted is less than the number of bits of the CSI to be transmitted, the number of the at least one uplink channel is greater than or equal to 2. That is, at least two uplink channels used to carry the CSI may be selected from the plurality of uplink channels according to the carrier information associated with the uplink channels and the preparation time of the CSI to be transmitted.

In some examples, a PUSCH for which an interval between a starting symbol of the PUSCH and the last symbol of the first control information is greater than or equal to the preparation time of the CSI to be transmitted and a carrier identifier associated with the PUSCH is the smallest, in the PUSCHs scheduled by the first control information, carries the CSI. In some embodiments, for example, the first control information schedules a PUSCH on a carrier 1 and a PUSCH on a carrier 2, and an interval between the starting symbol of the PUSCH on the carrier 1 and the last symbol of the first control information is less than the preparation time of the CSI, but an interval between the starting symbol of the PUSCH on the carrier 2 and the last symbol of the first control information is greater than or equal to the preparation time of the CSI, and the CSI reporting is triggered, then the CSI is multiplexed in the PUSCH on the carrier 2.

In some examples, a PUSCH for which an interval between a starting symbol of the PUSCH and the last symbol of the first control information is greater than or equal to the preparation time of the CSI to be transmitted and a carrier identifier associated with the PUSCH is the largest, in the PUSCHs scheduled by the first control information, carries the CSI. In some embodiments, for example, the first control information schedules a PUSCH on a carrier 1 and a PUSCH on a carrier 2, and intervals between starting symbols of the PUSCHs on the carrier 1 and the carrier 2 and the last symbol of the first control information is greater than or equal to the preparation time of the CSI, and the CSI reporting is triggered, then the CSI is multiplexed in the PUSCH on the carrier 2.

In some examples, a PUSCH carrying the CSI, for which an interval between a starting symbol of the PUSCH and the last symbol of the first control information is greater than or equal to the preparation time of the CSI to be transmitted in the PUSCHs scheduled by the first control information, is selected from the plurality of PUSCHs in the order from small to large of carrier identifiers associated with the PUSCHs. In some embodiments, for example, the first control information schedules PUSCHs on a carrier 1, carrier 2 and carrier 3, and an interval between a starting symbol of the PUSCH on the carrier 1 and the last symbol of the first control information is less than the preparation time of the CSI, but intervals between starting symbols of the PUSCHs on the carrier 2 and the carrier 3 and the last symbol of the first control information is greater than or equal to the preparation time of the CSI. The CSI to be transmitted may be multiplexed in the PUSCH on the carrier 2 first. In a case where the CSI to be transmitted cannot be fully carried in the PUSCH on the carrier 2, the remaining CSI of the CSI to be transmitted is then multiplexed in the PUSCH on the carrier 3, and so on, until the CSI to be transmitted is completely transmitted.

In some examples, the at least one uplink channel may be determined from the plurality of uplink channels based on the scheduling order of the uplink channels in the first control information and the preparation time of the CSI to be transmitted. In some embodiments, the at least one uplink channel may be selected in sequence from an uplink channel for which an interval between a starting symbol of the uplink channel and a last symbol of the first control information is greater than or equal to the preparation time of the CSI to be transmitted in the plurality of uplink channels, in the scheduling order of the uplink channels in the first control information. The scheduling order may be order from front to back, or the scheduling order may be order from back to front.

In this example, the at least one uplink channel may be determined from the plurality of uplink channels based on the scheduling order of the uplink channels in the first control information and the preparation time of the CSI to be transmitted, by which the operation is simple, no additional signaling overhead is required, and it is easy to implement.

In some examples, in a case where the number of bits allowed to carry the CSI in one uplink channel determined from the plurality of uplink channels based on the scheduling order of the uplink channels in the first control information and the preparation time of the CSI to be transmitted is less than the number of bits of the CSI to be transmitted, the number of the at least one uplink channel is greater than or equal to 2. That is, at least two uplink channels used to carry the CSI may be selected from the plurality of uplink channels according to the scheduling order of the uplink channels in the first control information and the preparation time of the CSI to be transmitted.

In some examples, a PUSCH for which an interval between a starting symbol of the PUSCH and the last symbol of the first control information is greater than or equal to the preparation time of the CSI to be transmitted and the scheduling order of the PUSCH in the first control information is the first, in the PUSCHs scheduled by the first control information, carries the CSI. In some embodiments, for example, the first control information schedules a PUSCH 1 and PUSCH 2, where the scheduling order of the PUSCHs in the first control information is the PUSCH 1, the PUSCH 2 in sequence, and an interval between a starting symbol of the PUSCH 1 and the last symbol of the first control information is less than the preparation time of the CSI, but an interval between a starting symbol of the PUSCH 2 and the last symbol of the first control information is greater than or equal to the preparation time of the CSI, and the CSI reporting is triggered, then the CSI is multiplexed in the PUSCH 2.

In some examples, a PUSCH for which an interval between a starting symbol of the PUSCH and the last symbol of the first control information is greater than or equal to the preparation time of the CSI to be transmitted and the scheduling order of the PUSCH in the first control information is the last, in the PUSCHs scheduled by the first control information, carries the CSI. For example, the first control information schedules a PUSCH 1 and PUSCH 2, where the scheduling order of the PUSCHs in the first control information is the PUSCH 1, the PUSCH 2 in sequence, and intervals between starting symbols of the PUSCH 1 and the PUSCH 2 and the last symbol of the first control information are greater than or equal to the preparation time of the CSI, and the CSI reporting is triggered, then the CSI is multiplexed in the PUSCH 2.

In some examples, a PUSCH carrying the CSI, for which an interval between a starting symbol of the PUSCH and the last symbol of the first control information is greater than or equal to the preparation time of the CSI to be transmitted in the PUSCHs scheduled by the first control information, is selected from the plurality of PUSCHs in order from small to large of identifiers of the PUSCHs. In some embodiments, for example, the first control information schedules a PUSCH 1, PUSCH 2 and PUSCH 3, and an interval between a starting symbol of the PUSCH 1 and the last symbol of the first control information is less than the preparation time of the CSI, but intervals between starting symbols of the PUSCH 2 and the PUSCH 3 and the last symbol of the first control information are greater than or equal to the preparation time of the CSI. The CSI to be transmitted may be multiplexed in the PUSCH 2 first. In a case where the CSI to be transmitted cannot be carried fully in the PUSCH 2, the remaining CSI of the CSI to be transmitted is then multiplexed in the PUSCH 3, and so on, until the CSI to be transmitted is completely transmitted. That is, the at least one uplink channel that meets the preparation time of the CSI to be transmitted may be selected in sequence from the plurality of uplink channels in order from back to front according to the scheduling order of the uplink channels in the first control information.

In some examples, the at least one uplink channel may be determined from the plurality of uplink channels based on the time domain locations occupied by the uplink channels and the preparation time of the CSI to be transmitted. In some embodiments, in second order of locations of starting symbols occupied by the plurality of uplink channels in time domain, the at least one uplink channel may be selected in sequence from an uplink channel for which an interval between a starting symbol of the uplink channel and the last symbol of the first control information is greater than or equal to the preparation time of the CSI to be transmitted, in the plurality of uplink channels. The second order may be order of from front to back, or the second order may be order of from back to front. Of course, the second order may also be other order, which is not limited to the embodiments of the present application.

In this example, the at least one uplink channel may be determined from the plurality of uplink channels based on the time domain locations occupied by the uplink channels and the preparation time of the CSI to be transmitted, by which the operation is simple, no additional signaling overhead is required, and it is easy to implement.

In some examples, in a case where the number of bits allowed to carry the CSI in one uplink channel determined from the plurality of uplink channels based on the time domain locations occupied by the uplink channels and the preparation time of the CSI to be transmitted is less than the number of bits of the CSI to be transmitted, the number of the at least one uplink channel is greater than or equal to 2. That is, at least two uplink channels used to carry the CSI may be selected from the plurality of uplink channels according to the time domain locations occupied by the uplink channels and the preparation time of the CSI to be transmitted.

In some examples, a PUSCH for which an interval between a starting symbol of the PUSCH and the last symbol of the first control information is greater than or equal to the preparation time of the CSI to be transmitted and the location of the starting symbol occupied by the PUSCH in time domain is the first, in the PUSCHs scheduled by the first control information, carries the CSI. In some embodiments, for example, the first control information schedules a PUSCH 1 and PUSCH 2, where the order of the starting symbols of the PUSCHs scheduled by the first control information is the PUSCH 1, the PUSCH 2 in sequence, and an interval between the starting symbol of the PUSCH 1 and the last symbol of the first control information is less than the preparation time of the CSI, but an interval between the starting symbol of the PUSCH 2 and the last symbol of the first control information is greater than or equal to the preparation time of the CSI, and the CSI reporting is triggered, then the CSI is multiplexed in the PUSCH 2.

In some examples, a PUSCH for which an interval between a starting symbol of the PUSCH and the last symbol of the first control information is greater than or equal to the preparation time of the CSI to be transmitted and the location of the starting symbol occupied by the PUSCH in time domain is the last, in the PUSCHs scheduled by the first control information, carries the CSI. In some embodiments, for example, the first control information schedules a PUSCH 1 and PUSCH 2, where the order of locations of the starting symbols occupied by the PUSCHs in time domain scheduled by the first control information is the PUSCH 1, the PUSCH 2 in sequence, and intervals between the starting symbols of the PUSCH 1, the PUSCH 2 and the last symbol of the first control information is greater than or equal to the preparation time of the CSI, and the CSI reporting is triggered, then the CSI is multiplexed in the PUSCH 2.

In some examples, a PUSCH carrying the CSI for which an interval between a starting symbol of the PUSCH and the last symbol of the first control information is greater than or equal to the preparation time of the CSI to be transmitted in the PUSCHs scheduled by the first control information, is selected from the plurality of PUSCHs in order from front to back of starting symbols occupied by the PUSCHs in time domain. In some embodiments, for example, the first control information schedules a PUSCH 1, PUSCH 2 and PUSCH 3, and an interval between a starting symbol location occupied by the PUSCH 1 in time domain and the last symbol of the first control information is less than the preparation time of the CSI, but intervals between starting symbol locations occupied by the PUSCH 2 and the PUSCH 3 in time domain and the last symbol of the first control information are greater than or equal to the preparation time of the CSI. The CSI to be transmitted may be multiplexed in the PUSCH 2 first. In a case where the CSI to be transmitted cannot be carried fully in the PUSCH 2, the remaining CSI of the CSI to be transmitted is then multiplexed in the PUSCH 3, and so on, until the CSI to be transmitted is completely transmitted.

In some examples, the at least one uplink channel may be determined from the plurality of uplink channels based on the carrier information associated with the uplink channels and the number of bits allowed to carry the CSI in the uplink channels. In some embodiments, the at least one uplink channel that meets the transmission requirement of the CSI to be transmitted may be selected from the plurality of uplink channels in sequence according to order from large to small of the number of bits allowed to carry the CSI in the plurality of uplink channels and first order of the carrier identifiers associated with the uplink channels. The first order may be order from small to large, or the first order may be order from large to small. Of course, the first order may also be other order, such as order of even-numbered bits from small to large, or order of odd-numbered bits from small to large, which is not limited to the present application.

In this example, the at least one uplink channel may be determined from the plurality of uplink channels based on the carrier information associated with the uplink channels and the number of bits allowed to carry the CSI in the uplink channels, by which the operation is simple, no additional signaling overhead is required, and it is easy to implement.

In some examples, in a case where the number of bits allowed to carry the CSI in one uplink channel determined from the plurality of uplink channels based on the carrier information associated with the uplink channels and the number of bits allowed to carry the CSI in the uplink channels is less than the number of bits of the CSI to be transmitted, the number of the at least one uplink channel is greater than or equal to 2. That is, at least two uplink channels used to carry the CSI may be selected from the plurality of uplink channels according to the carrier information associated with the uplink channels and the number of bits allowed to carry the CSI in the uplink channels.

In some examples, a PUSCH in the order from large to small of the number of bits allowed to carry the CSI in the PUSCHs scheduled by the first control information and associated with a frontmost carrier, carries the CSI. In some embodiments, for example, the first control information schedules a PUSCH 1 and PUSCH 2, and the number of bits allowed to carry the CSI in the PUSCH 1 is N1, and the number of bits allowed to carry the CSI in the PUSCH 2 is N2. In a case where the number of bits of the CSI to be transmitted is N, if N1>N, and N2>N, a PUSCH associated with the frontmost carrier identifier and meeting the preparation time of the CSI is selected from the PUSCH 1 and the PUSCH 2, and the CSI is multiplexed in the selected PUSCH. In a case where the number of bits of the CSI to be transmitted is N, if N1>N but N2<N, the CSI is multiplexed in the PUSCH 1, where an interval between a starting symbol of the PUSCH 1 and the last symbol of the first control information is not less than the preparation time of the CSI.

In some examples, a PUSCH for which the number of bits allowed to carry the CSI in the PUSCH meets the transmission requirement of the CSI to be transmitted and the carrier identifier associated with the PUSCH is the smallest, in the PUSCHs scheduled by the first control information, carries the CSI. In some embodiments, for example, the first control information schedules a PUSCH on a carrier 1 and a PUSCH on a carrier 2, and the number of bits allowed to carry the CSI in the PUSCH on the carrier 1 and the number of bits allowed to carry the CSI in the PUSCH on the carrier 2 are greater than or equal to the number of bits of CSI to be transmitted, and the CSI reporting is triggered, then the CSI is multiplexed in the PUSCH on the carrier 1.

In some examples, a PUSCH for which the number of bits allowed to carry the CSI in the PUSCH meets the transmission requirement of the CSI to be transmitted and the carrier identifier associated with the PUSCH is the largest, in the PUSCHs scheduled by the first control information, carries the CSI. In some embodiments, for example, the first control information schedules a PUSCH on a carrier 1 and a PUSCH on a carrier 2, and the number of bits allowed to carry the CSI in the PUSCH on the carrier 1 is greater than or equal to the number of bits of CSI to be transmitted and the number of bits allowed to carry the CSI in the PUSCH on the carrier 2 is also greater than or equal to the number of bits of CSI to be transmitted, and the CSI reporting is triggered, then the CSI is multiplexed in the PUSCH on the carrier 2.

In some examples, a PUSCH carrying the CSI is selected from the plurality of PUSCHs, in the order from large to small of the number of bits allowed to carry the CSI in the PUSCHs scheduled by the first control information and in the order from small to large of carrier identifiers associated with the PUSCHs. In some embodiments, for example, the first control information schedules PUSCHs on a carrier 1, carrier 2 and carrier 3. The CSI to be transmitted may be multiplexed in the PUSCH on the carrier 1 first. In a case where the CSI to be transmitted cannot be fully carried in the PUSCH on the carrier 1, the remaining CSI of the CSI to be transmitted is then multiplexed in the PUSCH on the carrier 2, and so on, until the CSI to be transmitted is completely transmitted. That is, the at least one uplink channel that meets the transmission requirement of the CSI to be transmitted may be selected in sequence from the plurality of uplink channels in the order from small to large of the carrier identifiers associated with the uplink channels.

In some examples, the at least one uplink channel may be determined from the plurality of uplink channels based on the scheduling order of the uplink channels in the first control information and the number of bits allowed to carry the CSI in the uplink channels. In some embodiments, the at least one uplink channel that meets the transmission requirement of the CSI to be transmitted may be selected in sequence from the plurality of uplink channels, according to the order from large to small of the number of bits allowed to carry the CSI in the plurality of uplink channels and the scheduling order of the uplink channels in the first control information. The scheduling order may be order from front to back, or the scheduling order may be order from back to front.

In some example, in a case where the number of bits allowed to carry the CSI in one uplink channel determined from the plurality of uplink channels based on the scheduling order of the uplink channels in the first control information and the number of bits allowed to carry the CSI in the uplink channels is less than the number of bits of the CSI to be transmitted, the number of the at least one uplink channel is greater than or equal to 2. That is, at least two uplink channels used to carry the CSI may be selected from the plurality of uplink channels according to the scheduling order of the uplink channels in the first control information and the number of bits allowed to carry the CSI in the uplink channels.

In this example, the at least one uplink channel may be determined from the plurality of uplink channels based on the scheduling order of the uplink channels in the first control information and the number of bits allowed to carry the CSI in the uplink channels, by which the operation is simple, no additional signaling overhead is required, and it is easy to implement.

In some examples, a PUSCH in the order from large to small of the number of bits allowed to carry the CSI in the PUSCHs scheduled by the first control information and having the frontmost order of the scheduling order of the uplink channels in the first control information, carries the CSI. In some embodiments, for example, the first control information schedules a PUSCH 1, PUSCH 2 and PUSCH 3, where the scheduling order of the PUSCHs in the first control information is the PUSCH 1, the PUSCH 2 and the PUSCH 3 in sequence, and the number of bits allowed to carry the CSI in the PUSCH 1 is less than the number of bits of the CSI to be transmitted, the number of bits allowed to carry the CSI in the PUSCH 2 and the number of bits allowed to carry the CSI in the PUSCH 3 are greater than or equal to the bits of the CSI to be transmitted, and the CSI reporting is triggered, then the CSI is multiplexed in the PUSCH 2.

In some examples, a PUSCH in the order from large to small of the number of bits allowed to carry the CSI in the PUSCHs scheduled by the first control information and having the last order of the scheduling order of the uplink channels in the first control information, carries the CSI. In some embodiments, for example, the first control information schedules a PUSCH 1, PUSCH 2 and PUSCH 3, where the scheduling order of the PUSCHs in the first control information is the PUSCH 1, the PUSCH 2 and the PUSCH 3 in sequence, and the number of bits allowed to carry the CSI in the PUSCH 1 is less than the number of bits of the CSI to be transmitted, the number of bits allowed to carry the CSI in the PUSCH 2 and the number of bits allowed to carry the CSI in the PUSCH 3 are greater than or equal to the bits of the CSI to be transmitted, and the CSI reporting is triggered, then the CSI is multiplexed in the PUSCH 3.

In some examples, a PUSCH carrying the CSI is selected from the plurality of PUSCHs, in the order from large to small of the number of bits allowed to carry the CSI in the PUSCHs scheduled by the first control information and in the order from front to back of the scheduling order of the uplink channels in the first control information. In some embodiments, for example, the first control information schedules a PUSCH 1, PUSCH 2 and PUSCH 3, where the scheduling order of the PUSCHs in the first control information is the PUSCH 1, the PUSCH 2 and the PUSCH 3 in sequence, and the number of bits allowed to carry the CSI in the PUSCH 1 is less than the number of bits of the CSI to be transmitted. The CSI to be transmitted may be multiplexed in the PUSCH 2 first. In a case where the CSI to be transmitted cannot be carried fully in the PUSCH 2, the remaining CSI of the CSI to be transmitted is then multiplexed in the PUSCH 3, and so on, until the CSI to be transmitted is completely transmitted.

In some examples, the at least one uplink channel may be determined from the plurality of uplink channels based on the time domain locations occupied by the uplink channels and the number of bits allowed to carry the CSI in the uplink channels. In some embodiments, the at least one uplink channel that meets the transmission requirement of the CSI to be transmitted may be selected in sequence from the plurality of uplink channels in the order from large to small of the number of bits allowed to carry the CSI in the plurality of uplink channels, and in second order of locations of starting symbols occupied by the plurality of uplink channels in time domain. The second order may be order from front to back, or the second order may be order from back to front. Of course, the second order may also be other order, which is not limited to the embodiments of the present application.

In this example, the at least one uplink channel may be determined from the plurality of uplink channels based on the time domain locations occupied by the uplink channels and the number of bits allowed to carry the CSI in the uplink channels, by which the operation is simple, no additional signaling overhead is required, and it is easy to implement.

In some examples, in a case where the number of bits allowed to carry the CSI in one uplink channel determined from the plurality of uplink channels based on the time domain locations occupied by the uplink channels and the number of bits allowed to carry the CSI in the uplink channels is less than the number of bits of the CSI to be transmitted, the number of the at least one uplink channel is greater than or equal to 2. That is, the terminal device may select at least two uplink channels used to carry the CSI from the plurality of uplink channels according to the time domain locations occupied by the uplink channels and the number of bits allowed to carry the CSI in the uplink channels.

In some examples, a PUSCH meeting the transmission requirement of the CSI to be transmitted and having the frontmost location of the locations of the starting symbols occupied by the plurality of uplink channels in time domain, in the PUSCHs scheduled by the first control information, carries the CSI. In some embodiments, for example, the first control information schedules a PUSCH 1, PUSCH 2 and PUSCH 3, where the order from front to back of starting symbols of the PUSCH 1, the PUSCH 2 and the PUSCH 3 in time domain is the PUSCH 1, the PUSCH 2 and the PUSCH 3 in sequence, and the number of bits allowed to carry the CSI in the PUSCH 1 is less than the number of bits of the CSI to be transmitted, the number of bits allowed to carry the CSI in the PUSCH 2 and the number of bits allowed to carry the CSI in the PUSCH 3 are greater than or equal to the number of bits of the CSI to be transmitted, and the CSI reporting is triggered, then the CSI is multiplexed in the PUSCH 2.

In some examples, a PUSCH meeting the transmission requirement of the CSI to be transmitted and having the last location of the locations of the starting symbols occupied by the plurality of uplink channels in time domain, in the PUSCHs scheduled by the first control information, carries the CSI. In some embodiments, for example, the first control information schedules a PUSCH 1, PUSCH 2 and PUSCH 3, where the order from front to back of starting symbols of the PUSCH 1, the PUSCH 2 and the PUSCH 3 in time domain is the PUSCH 1, the PUSCH 2 and the PUSCH 3 in sequence, and the number of bits allowed to carry the CSI in the PUSCH 1 is less than the number of bits of the CSI to be transmitted, the number of bits allowed to carry the CSI in the PUSCH 2 and the number of bits allowed to carry the CSI in the PUSCH 3 are greater than or equal to the number of bits of the CSI to be transmitted, and the CSI reporting is triggered, then the CSI is multiplexed in the PUSCH 3.

In some examples, a PUSCH that meets the transmission requirement of the CSI to be transmitted is selected from the plurality of PUSCHs, in the order from large to small of the number of bits allowed to carry the CSI in the PUSCHs scheduled by the first control information and in the order from front to back of the locations of the starting symbols occupied by the plurality of uplink channels in time domain. In some embodiments, for example, the first control information schedules a PUSCH 1, PUSCH 2 and PUSCH 3, where the order from front to back of the starting symbols of PUSCH 1, PUSCH 2 and PUSCH 3 in time domain is the PUSCH 1, the PUSCH 2 and the PUSCH 3 in sequence, and the number of bits allowed to carry the CSI in the PUSCH 1 is less than the number of bits of the CSI to be transmitted. The CSI to be transmitted may be multiplexed in the PUSCH 2 first. In a case where the CSI to be transmitted cannot be carried fully in the PUSCH 2, the remaining CSI of the CSI to be transmitted is then multiplexed in the PUSCH 3, and so on, until the CSI to be transmitted is completely transmitted.

In some examples, the at least one uplink channel may be determined from the plurality of uplink channels based on the number of bits allowed to carry the CSI in the uplink channels and the preparation time of the CSI to be transmitted. In some embodiments, the at least one uplink channel that meets a transmission requirement of the CSI to be transmitted may be selected from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels.

In some examples, in a case where the number of bits allowed to carry the CSI in one uplink channel determined from the plurality of uplink channels based on the number of bits allowed to carry the CSI in the uplink channels and the preparation time of the CSI to be transmitted is less than the number of bits of the CSI to be transmitted, the number of the at least one uplink channel is greater than or equal to 2. That is, at least two uplink channels used to carry the CSI may be selected from the plurality of uplink channels according to the number of bits allowed to carry the CSI in the uplink channels and the preparation time of the CSI to be transmitted.

In some examples, the first control information schedules a PUSCH 1 and PUSCH 2, where an interval between a starting symbol of the PUSCH 1 and the last symbol of the first control information is greater than the preparation time of the CSI, and an interval between a starting symbol of the PUSCH 2 and the last symbol of the first control information is also greater than the preparation time of the CSI. Assuming that the number of bits of the CSI to be transmitted is N, the number of bits of the CSI that can be carried by the PUSCH 1 is N1, and the number of bits of the CSI that can be carried by the PUSCH 2 is N2, where N1<N but N2>N, the CSI is multiplexed in the PUSCH 2.

### Implementation 3

The at least one uplink channel may be determined from the plurality of uplink channels based on three of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

Optionally, in Implementation 3, the at least one uplink channel may be determined from the plurality of uplink channels based at least on the preparation time of the CSI to be transmitted and/or the number of bits allowed to carry the CSI in the uplink channels.

In some examples, the at least one uplink channel may be determined from the plurality of uplink channels based on the carrier information associated with the uplink channels, the number of bits allowed to carry the CSI in the uplink channels, and the preparation time of the CSI to be transmitted. In some embodiments, the at least one uplink channel that meets a transmission requirement of the CSI to be transmitted may be selected from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in first order of carrier identifiers associated with the uplink channels. The first order may be order from small to large, or the first order may be order from large to small. Of course, the first order may also be other order, such as order of even-numbered bits from small to large, or order of odd-numbered bits from small to large, which is not limited to the present application.

In this example, the at least one uplink channel may be determined from the plurality of uplink channels based on the carrier information associated with the uplink channels, the number of bits allowed to carry the CSI in the uplink channels, and the preparation time of the CSI to be transmitted, by which the operation is simple, no additional signaling overhead is required, and it is easy to implement.

In some examples, in a case where the number of bits allowed to carry the CSI in one uplink channel determined from the plurality of uplink channels based on the carrier information associated with the uplink channels, the number of bits allowed to carry the CSI in the uplink channels and the preparation time of the CSI to be transmitted is less than the number of bits of the CSI to be transmitted, the number of the at least one uplink channel is greater than or equal to 2. That is, at least two uplink channels used to carry the CSI may be selected from the plurality of uplink channels according to the carrier information associated with the uplink channels, the number of bits allowed to carry the CSI in the uplink channels, and the preparation time of the CSI to be transmitted.

In some examples, a PUSCH meeting the preparation time and the transmission requirement of the CSI to be transmitted and associated with the smallest carrier identifier in the PUSCHs scheduled by the first control information, carries the CSI. In some embodiments, for example, the first control information schedules PUSCHs on a carrier 1, carrier 2 and carrier 3, and an interval between a starting symbol occupied by the PUSCH on the carrier 1 in time domain and the last symbol of the first control information is less than the preparation time of the CSI, but intervals between starting symbols occupied by the PUSCH on the carrier 2 and the carrier 3 in time domain and the last symbol of the first control information are also greater than the preparation time of the CSI, the number of bits allowed to carry the CSI in the PUSCH on the carrier 1, the number of bits allowed to carry the CSI in the PUSCH on the carrier 2 and the number of bits allowed to carry the CSI in the PUSCH on the carrier 3 are all greater than or equal to the bits of the CSI to be transmitted, and the CSI reporting is triggered, then the CSI is multiplexed in the PUSCH on the carrier 2.

In some examples, a PUSCH meeting the preparation time and the transmission requirement of the CSI to be transmitted and associated with the largest carrier identifier in the PUSCHs scheduled by the first control information, carries the CSI. In some embodiments, for example, the first control information schedules PUSCHs on a carrier 1, carrier 2 and carrier 3, and an interval between a starting symbol occupied by the PUSCH on the carrier 1 in time domain and the last symbol of the first control information is less than the preparation time of the CSI, but intervals between starting symbols occupied by the PUSCH on the carrier 2 and the carrier 3 in time domain and the last symbol of the first control information are also greater than the preparation time of the CSI, the number of bits allowed to carry the CSI in the PUSCH on the carrier 1, the number of bits allowed to carry the CSI in the PUSCH on the carrier 2 and the number of bits allowed to carry the CSI in the PUSCH on the carrier 3 are all greater than or equal to the bits of the CSI to be transmitted, and the CSI reporting is triggered, then the CSI is multiplexed in the PUSCH on the carrier 3.

In some examples, a PUSCH carrying the CSI is selected from the plurality of PUSCHs, which meets the preparation time and the transmission requirement of the CSI to be transmitted in the PUSCHs scheduled by the first control information, and is selected in the order from small to large of the carrier identifiers associated with the PUSCHs. In some embodiments, for example, the first control information schedules PUSCHs on a carrier 1, carrier 2 and carrier 3, and an interval between a starting symbol occupied by the PUSCH on the carrier 1 in time domain and the last symbol of the first control information is less than the preparation time of the CSI, but intervals between starting symbols occupied by the PUSCHs on the carrier 2 and the carrier 3 in time domain and the last symbol of the first control information are greater than or equal to the preparation time of the CSI. The CSI to be transmitted may be multiplexed in the PUSCH on the carrier 2 first. In a case where the CSI to be transmitted cannot be fully carried in the PUSCH on the carrier 2, the remaining CSI of the CSI to be transmitted is then multiplexed in the PUSCH on the carrier 3, and so on, until the CSI to be transmitted is completely transmitted.

In some examples, the at least one uplink channel may be determined from the plurality of uplink channels based on the scheduling order of the uplink channels in the first control information, the number of bits allowed to carry the CSI in the uplink channels, and the preparation time of the CSI to be transmitted. In some embodiments, the at least one uplink channel that meets a transmission requirement of the CSI to be transmitted may be selected from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in the scheduling order of the uplink channels in the first control information. The scheduling order may be order from front to back, or the scheduling order may be order from back to front.

In this example, the at least one uplink channel may be determined from the plurality of uplink channels based on the scheduling order of the uplink channels in the first control information, the number of bits allowed to carry the CSI in the uplink channels, and the preparation time of the CSI to be transmitted, by which the operation is simple, no additional signaling overhead is required, and it is easy to implement.

In some examples, in a case where the number of bits allowed to carry the CSI in one uplink channel determined from the plurality of uplink channels based on the scheduling order of the uplink channels in the first control information, the bits allowed to carry the CSI in the uplink channels and the preparation time of the CSI to be transmitted is less than the number of bits of the CSI to be transmitted, the number of the at least one uplink channel is greater than or equal to 2. That is, the terminal device may select at least two uplink channels used to carry the CSI from the plurality of uplink channels according to the scheduling order of the uplink channels in the first control information, the number of bits allowed to carry the CSI in the uplink channels, and the preparation time of the CSI to be transmitted.

In some examples, a PUSCH meeting the preparation time and the transmission requirement of the CSI to be transmitted and having the frontmost order of the scheduling order of the uplink channels in the first control information, in the PUSCHs scheduled by the first control information, carries the CSI. In some embodiments, for example, the first control information schedules a PUSCH 1, PUSCH 2 and PUSCH 3, where the scheduling order of the PUSCHs in the first control information is the PUSCH 1, the PUSCH 2 and the PUSCH 3 in sequence, and an interval between a starting symbol occupied by the PUSCH 1 in time domain and the last symbol of the first control information is less than the preparation time of the CSI, but intervals between starting symbols occupied by the PUSCH 2 and the PUSCH 3 in time domain and the last symbol of the first control information are also greater than the preparation time of the CSI, and the number of bits allowed to carry the CSI in the PUSCH 1, the number of bits allowed to carry the CSI in the PUSCH 2 and the number of bits allowed to carry the CSI in the PUSCH 3 are all greater than or equal to the number of bits of the CSI to be transmitted, and the CSI reporting is triggered, then the CSI is multiplexed in the PUSCH 2.

In some examples, a PUSCH meeting the preparation time and the transmission requirement of the CSI to be transmitted and having the last order of the scheduling order of the uplink channels in the first control information, in the PUSCHs scheduled by the first control information, carries the CSI. In some embodiments, for example, the first control information schedules a PUSCH 1, PUSCH 2 and PUSCH 3, where the scheduling order of the PUSCHs in the first control information is the PUSCH 1, the PUSCH 2 and the PUSCH 3 in sequence, and an interval between a starting symbol occupied by the PUSCH 1 in time domain and the last symbol of the first control information is less than the preparation time of the CSI, but intervals between starting symbols occupied by the PUSCH 2 and the PUSCH 3 in time domain and the last symbol of the first control information are also greater than the preparation time of the CSI, and the number of bits allowed to carry the CSI in the PUSCH 1, the number of bits allowed to carry the CSI in the PUSCH 2 and the number of bits allowed to carry the CSI in the PUSCH 3 are all greater than or equal to the number of bits of the CSI to be transmitted, and the CSI reporting is triggered, then the CSI is multiplexed in the PUSCH 3.

In some examples, one or more PUSCHs meeting the transmission requirement of the CSI to be transmitted are selected from the plurality of PUSCHs, which meet the preparation time of the CSI to be transmitted and are selected in order from front to back of the scheduling order of the uplink channels in the first control information, in the PUSCHs scheduled by the first control information. In some embodiments, for example, the first control information schedules a PUSCH 1, PUSCH 2 and PUSCH 3, where the scheduling order of the PUSCHs in the first control information is the PUSCH 1, the PUSCH 2 and the PUSCH 3 in sequence, and an interval between a starting symbol occupied by the PUSCH 1 in time domain and the last symbol of the first control information is less than the preparation time of the CSI, but intervals between starting symbols occupied by the PUSCH 2 and the PUSCH 3 in time domain and the last symbol of the first control information are also greater than the preparation time of the CSI. The CSI to be transmitted may be multiplexed in the PUSCH 2 first. In a case where the CSI to be transmitted cannot be carried fully on the PUSCH 2, the remaining CSI of the CSI to be transmitted is then multiplexed in the PUSCH 3, and so on, until the CSI to be transmitted is completely transmitted.

In some examples, the at least one uplink channel may be determined from the plurality of uplink channels based on the time domain locations occupied by the uplink channels, the number of bits allowed to carry the CSI in the uplink channels, and the preparation time of the CSI to be transmitted. In some embodiments, the at least one uplink channel that meets the preparation time and the transmission requirement of the CSI to be transmitted may be selected in sequence from the plurality of uplink channels in order from large to small of the number of bits allowed to carry the CSI in the plurality of uplink channels and in second order of locations of starting symbols occupied by the plurality of uplink channels in time domain. The second order may be order from front to back, or the second order may be order from back to front. Of course, the second order may also be other order, and which is not limited to the embodiments of the present application.

In this example, the at least one uplink channel may be determined from the plurality of uplink channels based on the time domain locations occupied by the uplink channels, the number of bits allowed to carry the CSI in the uplink channels, and the preparation time of the CSI to be transmitted, by which the operation is simple, no additional signaling overhead is required, and it is easy to implement.

In some examples, in a case where the number of bits allowed to carry the CSI in one uplink channel determined from the plurality of uplink channels based on the time domain locations occupied by the uplink channels, the number of bits allowed to carry the CSI in the uplink channels, and the preparation time of the CSI to be transmitted is less than the bits of CSI to be transmitted, the number of the at least one uplink channel is greater than or equal to 2. That is, at least two uplink channels used to carry the CSI may be selected from the plurality of uplink channels according to the time domain locations occupied by the uplink channels, the number of bits allowed to carry the CSI in the uplink channels, and the preparation time of the CSI to be transmitted.

In some examples, a PUSCH meeting the preparation time and the transmission requirement of the CSI to be transmitted and having the frontmost location of the locations in the starting symbols occupied by the plurality of uplink channels in time domain, in the PUSCHs scheduled by the first control information, carries the CSI. In some embodiments, for example, the first control information schedules a PUSCH 1, PUSCH 2 and PUSCH 3, where the order from front to back of the locations of the starting symbols occupied by the PUSCH 1, the PUSCH 2 and the PUSCH 3 in time domain is the PUSCH 1, the PUSCH 2 and the PUSCH 3 in sequence, and an interval between a starting symbol occupied by the PUSCH 1 in time domain and the last symbol of the first control information is less than the preparation time of the CSI, but intervals between starting symbols occupied by the PUSCH 2 and the PUSCH 3 in time domain and the last symbol of the first control information are also greater than the preparation time of the CSI, and the number of bits allowed to carry the CSI in the PUSCH 1, the number of bits allowed to carry the CSI in the PUSCH 2 and the number of bits allowed to carry the CSI in the PUSCH 3 are all greater than or equal to the number of bits of the CSI to be transmitted, and the CSI reporting is triggered, then the CSI is multiplexed in the PUSCH 2.

In some examples, a PUSCH meeting the preparation time and the transmission requirement of the CSI to be transmitted and having the last location of the locations in the starting symbols of the plurality of uplink channels in time domain, in the PUSCHs scheduled by the first control information, carries the CSI. In some embodiments, for example, the first control information schedules a PUSCH 1, PUSCH 2 and PUSCH 3, where the order from front to back of the locations of the starting symbols occupied by the PUSCH 1, the PUSCH 2 and the PUSCH 3 in time domain is the PUSCH 1, the PUSCH 2 and the PUSCH 3 in sequence, and an interval between a starting symbol occupied by the PUSCH 1 in time domain and the last symbol of the first control information is less than the preparation time of the CSI, but intervals between starting symbols occupied by the PUSCH 2 and the PUSCH 3 in time domain and the last symbol of the first control information are also greater than the preparation time of the CSI, and the number of bits allowed to carry the CSI in the PUSCH 1, the number of bits allowed to carry the CSI in the PUSCH 2 and the number of bits allowed to carry the CSI in the PUSCH 3 are all greater than or equal to the number of bits of the CSI to be transmitted, and the CSI reporting is triggered, then the CSI is multiplexed in the PUSCH 3.

In some examples, one or more PUSCH meeting the transmission requirement of the CSI to be transmitted are selected from the plurality of PUSCHs, which meet the preparation time of the CSI to be transmitted and are selected in order from front to back of the locations of the starting symbols occupied the plurality of uplink channels in time domain, in the PUSCHs scheduled by the first control information. In some embodiments, for example, the first control information schedules a PUSCH 1, PUSCH 2 and PUSCH 3, where the order from front to back of the locations of the starting symbols occupied by the PUSCH 1, the PUSCH 2 and the PUSCH 3 in time domain is the PUSCH 1, the PUSCH 2 and the PUSCH 3 in sequence, and an interval between the starting symbol occupied by the PUSCH 1 in time domain and the last symbol of the first control information is less than the preparation time of the CSI, but intervals between the starting symbols occupied by the PUSCH 2 and the PUSCH 3 in time domain and the last symbol of the first control information are also greater than the preparation time of the CSI. The CSI to be transmitted may be multiplexed in the PUSCH 2 first. In a case where the CSI to be transmitted cannot be fully carried in the PUSCH 2, the remaining CSI of the CSI to be transmitted is then multiplexed in the PUSCH 3, and so on, until the CSI to be transmitted is completely transmitted.

Therefore, in the embodiments of the present application, in a case where the first control information is used to schedule the plurality of uplink channels and different uplink channels in the plurality of uplink channels are carried by different carriers, the at least one uplink channel used to carry the CSI can be determined from the plurality of uplink channels, and the method for determining the uplink channel used to carry the CSI is clarified. The CSI may be transmitted by one or more carriers, thereby improving the efficiency of the CSI reporting.

Furthermore, the terminal device determines the at least one uplink channel used to carry the CSI from the plurality of uplink channels based on at least one of the following: carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

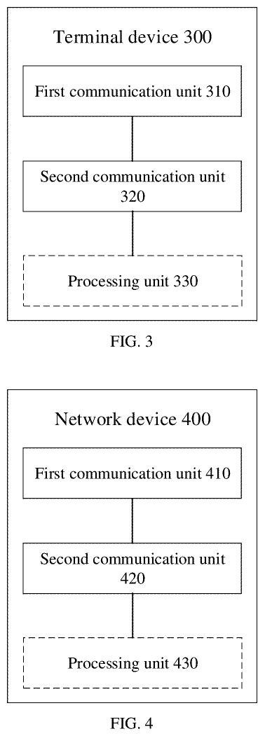

The method embodiments of the present application are described in detail above in conjunction with FIG. 2. Apparatus embodiments of the present application will be described in detail below in conjunction with FIG. 3 to FIG. 7. It should be understood that the apparatus embodiments and the method embodiments correspond to each other, and similar descriptions may refer to the method embodiments.

FIG. 3 shows a schematic block diagram of a terminal device 300 according to the embodiments of the present application. As shown in FIG. 3, the terminal device 300 includes:
a first communication unit 310, configured to receive first control information, where the first control information is used to schedule a plurality of uplink channels, and different uplink channels of the plurality of uplink channels are carried by different carriers; and
a second communication unit 320, configured to at least transmit at least one uplink channel of the plurality of uplink channels, where the at least one uplink channel carries channel state information (CSI) to be transmitted.

In some embodiments, the terminal device 300 further includes:
a processing unit 330, configured to determine the at least one uplink channel from the plurality of uplink channels according to first information;
where the first information includes at least one of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

In some embodiments, in a case where the first information at least includes the indication information carried in the first control information, the first control information includes a first information field, where the first information field is used to indicate an identifier of an uplink channel used to carry the CSI in the plurality of uplink channels, or the first information field is used to indicate an identifier of a carrier associated with an uplink channel used to carry the CSI in the plurality of uplink channels;
where the processing unit 330 is configured to:
determine the at least one uplink channel from the plurality of uplink channels according to the first information field.

In some embodiments, in the case where the first information field is used to indicate the identifier of the uplink channel used to carry the CSI in the plurality of uplink channels, a correspondence between a value of the first information field and the identifier of the uplink channel is agreed upon by a protocol, or the correspondence between the value of the first information field and the identifier of the uplink channel is configured by a network device through a high layer signaling.

In some embodiments, in the case where the first information field is used to indicate the identifier of the carrier associated with the uplink channel used to carry the CSI in the plurality of uplink channels, a correspondence between a value of the first information field and the identifier of the carrier associated with the uplink channel is agreed upon by a protocol, or the correspondence between the value of the first information field and the identifier of the carrier associated with the uplink channel is configured by a network device through a high layer signaling.

In some embodiments, in a case where the first information at least includes the indication information carried in the first control information, the first control information includes at least one second information field, where the at least one second information field corresponds to the at least one uplink channel respectively, or the at least one second information field corresponds to a carrier associated with the at least one uplink channel respectively;
where the processing unit 330 is configured to:
determine the at least one uplink channel from the plurality of uplink channels according to the at least one second information field.

In some embodiments, in a case where the first information at least includes the carrier information associated with the uplink channels, the processing unit 330 is configured to:
select the at least one uplink channel used to carry the CSI in sequence from the plurality of uplink channels in first order of carrier identifiers associated with the uplink channels.

In some embodiments, in a case where the first information at least includes the scheduling order of the uplink channels in the first control information, the processing unit 330 is configured to:
select the at least one uplink channel used to carry the CSI in sequence from the plurality of uplink channels in the scheduling order of the uplink channels in the first control information.

In some embodiments, in a case where the first information at least includes the time domain locations occupied by the uplink channels, the determining, the processing unit 330 is configured to:
select the at least one uplink channel used to carry the CSI in sequence from the plurality of uplink channels in second order of locations of starting symbols occupied by the plurality of uplink channels in time domain.

In some embodiments, in a case where the first information at least includes the preparation time of the CSI to be transmitted, the processing unit 330 is configured to:
selecting the at least one uplink channel from an uplink channel for which an interval between a starting symbol of the uplink channel and a last symbol of the first control information is greater than or equal to the preparation time of the CSI to be transmitted, in the plurality of uplink channels.

In some embodiments, in a case where the first information at least includes the number of bits allowed to carry the CSI in the uplink channels, the processing unit 330 is configured to:
select the at least one uplink channel that meets a transmission requirement of the CSI to be transmitted from the plurality of uplink channels in order from large to small of the number of bits allowed to carry the CSI in the plurality of uplink channels.

In some embodiments, in a case where the first information at least includes the priorities of the uplink channels, the determining, by the terminal device, the processing unit 330 is configured to:
select the at least one uplink channel used to carry the CSI in sequence from the plurality of uplink channels in order of priorities of the plurality of uplink channels.

In some embodiments, in a case where the first information at least includes the priorities of the uplink channels and the priority of the CSI, the processing unit 330 is configured to:
select the at least one uplink channel used to carry the CSI from an uplink channel having a same priority as the priority of the CSI, in the plurality of uplink channels.

In some embodiments, in a case where the first information at least includes the carrier information associated with the uplink channels and the preparation time of the CSI to be transmitted, the processing unit 330 is configured to:
select the at least one uplink channel in sequence from an uplink channel for which an interval between a starting symbol of the uplink channel and a last symbol of the first control information is greater than or equal to the preparation time of the CSI to be transmitted in the plurality of uplink channels, in first order of carrier identifiers associated with the uplink channels.

In some embodiments, in a case where the first information at least includes the scheduling order of the uplink channels in the first control information and the preparation time of the CSI to be transmitted, the processing unit 330 is configured to:
select the at least one uplink channel in sequence from an uplink channel for which an interval between a starting symbol of the uplink channel and a last symbol of the first control information is greater than or equal to the preparation time of the CSI to be transmitted in the plurality of uplink channels, in the scheduling order of the uplink channels in the first control information.

In some embodiments, in a case where the first information at least includes the time domain locations occupied by the uplink channels and the preparation time of the CSI to be transmitted, the processing unit 330 is configured to:
select the at least one uplink channel in sequence from an uplink channel for which an interval between a starting symbol of the uplink channel and a last symbol of the first control information is greater than or equal to the preparation time of the CSI to be transmitted in the plurality of uplink channels, in second order of locations of starting symbols occupied by the plurality of uplink channels in time domain.

In some embodiments, in a case where the first information at least includes the carrier information associated with the uplink channels and the number of bits allowed to carry the CSI in the uplink channels, the processing unit 330 is configured to:
select the at least one uplink channel that meets a transmission requirement of the CSI to be transmitted in sequence from the plurality of uplink channels, in order from large to small of the number of bits allowed to carry the CSI in the plurality of uplink channels and in first order of carrier identifiers associated with the uplink channels.

In some embodiments, in a case where the first information at least includes the scheduling order of the uplink channels in the first control information and the number of bits allowed to carry the CSI in the uplink channels, the processing unit 330 is configured to:
select the at least one uplink channel that meets a transmission requirement of the CSI to be transmitted in sequence from the plurality of uplink channels, in order from large to small of the number of bits allowed to carry the CSI in the plurality of uplink channels and in the scheduling order of the uplink channels in the first control information.

In some embodiments, in a case where the first information at least includes the time domain locations occupied by the uplink channels and the number of bits allowed to carry the CSI in the uplink channels, the processing unit 330 is configured to:
select the at least one uplink channel that meets a transmission requirement of the CSI to be transmitted from the plurality of uplink channels, in order from large to small of the number of bits allowed to carry the CSI in the plurality of uplink channels and in second order of locations of starting symbols occupied by the plurality of uplink channels in time domain.

In some embodiments, in a case where the first information at least includes the number of bits allowed to carry the CSI in the uplink channels and the preparation time of the CSI to be transmitted, the processing unit 330 is configured to:
select the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels.

In some embodiments, in a case where the first information at least includes the carrier information associated with the uplink channels, the number of bits allowed to carry the CSI in the uplink channels, and the preparation time of the CSI to be transmitted, the processing unit 330 is configured to:
select the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in first order of carrier identifiers associated with the uplink channels.

In some embodiments, in a case where the first information at least includes the scheduling order of the uplink channels in the first control information, the number of bits allowed to carry the CSI in the uplink channels, and the preparation time of the CSI to be transmitted, the processing unit 330 is configured to:
select the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in the scheduling order of the uplink channels in the first control information.

In some embodiments, in a case where the first information at least includes the time domain locations occupied by the uplink channels, the number of bits allowed to carry the CSI in the uplink channels, and the preparation time of the CSI to be transmitted, the processing unit 330 is configured to:
select the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in second order of locations of starting symbols occupied by the plurality of uplink channels in time domain.

In some embodiments, in a case where the number of bits allowed to carry the CSI in one uplink channel determined from the plurality of uplink channels based on the first information is less than a number of bits of the CSI to be transmitted, a number of the at least one uplink channel is greater than or equal to 2.

In some embodiments, in a case where only one CSI trigger field exists in the first control information, a correspondence between the CSI triggering field and CSI reporting is configured by a network device through a high layer signaling.

In some embodiments, the CSI to be transmitted includes all CSI to be transmitted, or the CSI to be transmitted includes a first part of all CSI to be transmitted.

In some embodiments, the CSI to be transmitted is aperiodic CSI, or the CSI to be transmitted is semi-persistent CSI.

In some embodiments, the communication unit above may be a communication interface or a transceiver, or an input/output interface of a communication chip or a system on chip. The processing unit above may be one or more processors.

It should be understood that the terminal device 300 according to the embodiments of the present application may correspond to the terminal device in the method embodiments of the present application, and the above-mentioned and other operations and/or functions of various units in the terminal device 300 are respectively for implementing the corresponding processes of the terminal device in the method 200 shown in FIG. 2, which will not be repeated here for the sake of brevity.

FIG. 4 shows a schematic block diagram of a network device 400 according to the embodiments of the present application. As shown in FIG. 4, the network device 400 includes:
a first communication unit 410, configured to transmit first control information, where the first control information is used to schedule a plurality of uplink channels, and different uplink channels of the plurality of uplink channels are carried by different carriers; and
a second communication unit 420, configured to at least receive at least one uplink channel of the plurality of uplink channels, where the at least one uplink channel carries channel state information (CSI) to be transmitted.

In some embodiments, the network device 400 further includes: a processing unit 430;
the processing unit 430 is configured to determine the at least one uplink channel from the plurality of uplink channels according to first information.

The first information includes at least one of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

In some embodiments, in a case where the first information at least includes the indication information carried in the first control information, the first control information includes a first information field, where the first information field is used to indicate an identifier of an uplink channel used to carry the CSI in the plurality of uplink channels, or the first information field is used to indicate an identifier of a carrier associated with an uplink channel used to carry the CSI in the plurality of uplink channels.

The processing unit 430 is configured to:
determine the at least one uplink channel from the plurality of uplink channels according to the first information field.

In some embodiments, in the case where the first information field is used to indicate the identifier of the uplink channel used to carry the CSI in the plurality of uplink channels, a correspondence between a value of the first information field and the identifier of the uplink channel is agreed upon by a protocol, or the correspondence between the value of the first information field and the identifier of the uplink channel is configured by a network device through a high layer signaling.

In some embodiments, in the case where the first information field is used to indicate the identifier of the carrier associated with the uplink channel used to carry the CSI in the plurality of uplink channels, a correspondence between a value of the first information field and the identifier of the carrier associated with the uplink channel is agreed upon by a protocol, or the correspondence between the value of the first information field and the identifier of the carrier associated with the uplink channel is configured by a network device through a high layer signaling.

In some embodiments, in a case where the first information at least includes the indication information carried in the first control information, the first control information includes at least one second information field, where the at least one second information field corresponds to the at least one uplink channel respectively, or the at least one second information field corresponds to a carrier associated with the at least one uplink channel respectively;
where the processing unit 430 is configured to:
determine the at least one uplink channel from the plurality of uplink channels according to the at least one second information field.

In some embodiments, in a case where the first information at least includes the carrier information associated with the uplink channels, the processing unit 430 is configured to:
select the at least one uplink channel used to carry the CSI in sequence from the plurality of uplink channels in first order of carrier identifiers associated with the uplink channels.

In some embodiments, in a case where the first information at least includes the scheduling order of the uplink channels in the first control information, the processing unit 430 is configured to:
select the at least one uplink channel used to carry the CSI in sequence from the plurality of uplink channels in the scheduling order of the uplink channels in the first control information.

In some embodiments, in a case where the first information at least includes the time domain locations occupied by the uplink channels, the determining, the processing unit 430 is configured to:
select the at least one uplink channel used to carry the CSI in sequence from the plurality of uplink channels in second order of locations of starting symbols occupied by the plurality of uplink channels in time domain.

In some embodiments, in a case where the first information at least includes the preparation time of the CSI to be transmitted, the processing unit 430 is configured to:
selecting the at least one uplink channel from an uplink channel for which an interval between a starting symbol of the uplink channel and a last symbol of the first control information is greater than or equal to the preparation time of the CSI to be transmitted, in the plurality of uplink channels.

In some embodiments, in a case where the first information at least includes the number of bits allowed to carry the CSI in the uplink channels, the processing unit 430 is configured to:
select the at least one uplink channel that meets a transmission requirement of the CSI to be transmitted from the plurality of uplink channels in order from large to small of the number of bits allowed to carry the CSI in the plurality of uplink channels.

In some embodiments, in a case where the first information at least includes the priorities of the uplink channels, the determining, by the terminal device, the processing unit 430 is configured to:
select the at least one uplink channel used to carry the CSI in sequence from the plurality of uplink channels in order of priorities of the plurality of uplink channels.

In some embodiments, in a case where the first information at least includes the priorities of the uplink channels and the priority of the CSI, the processing unit 430 is configured to:
select the at least one uplink channel used to carry the CSI from an uplink channel having a same priority as the priority of the CSI, in the plurality of uplink channels.

In some embodiments, in a case where the first information at least includes the carrier information associated with the uplink channels and the preparation time of the CSI to be transmitted, the processing unit 430 is configured to:
select the at least one uplink channel in sequence from an uplink channel for which an interval between a starting symbol of the uplink channel and a last symbol of the first control information is greater than or equal to the preparation time of the CSI to be transmitted in the plurality of uplink channels, in first order of carrier identifiers associated with the uplink channels.

In some embodiments, in a case where the first information at least includes the scheduling order of the uplink channels in the first control information and the preparation time of the CSI to be transmitted, the processing unit 430 is configured to:
select the at least one uplink channel in sequence from an uplink channel for which an interval between a starting symbol of the uplink channel and a last symbol of the first control information is greater than or equal to the preparation time of the CSI to be transmitted in the plurality of uplink channels, in the scheduling order of the uplink channels in the first control information.

In some embodiments, in a case where the first information at least includes the time domain locations occupied by the uplink channels and the preparation time of the CSI to be transmitted, the processing unit 430 is configured to:
select the at least one uplink channel in sequence from an uplink channel for which an interval between a starting symbol of the uplink channel and a last symbol of the first control information is greater than or equal to the preparation time of the CSI to be transmitted in the plurality of uplink channels, in second order of locations of starting symbols occupied by the plurality of uplink channels in time domain.

In some embodiments, in a case where the first information at least includes the carrier information associated with the uplink channels and the number of bits allowed to carry the CSI in the uplink channels, the processing unit 430 is configured to:
select the at least one uplink channel that meets a transmission requirement of the CSI to be transmitted in sequence from the plurality of uplink channels, in order from large to small of the number of bits allowed to carry the CSI in the plurality of uplink channels and in first order of carrier identifiers associated with the uplink channels.

In some embodiments, in a case where the first information at least includes the scheduling order of the uplink channels in the first control information and the number of bits allowed to carry the CSI in the uplink channels, the processing unit 430 is configured to:
select the at least one uplink channel that meets a transmission requirement of the CSI to be transmitted in sequence from the plurality of uplink channels, in order from large to small of the number of bits allowed to carry the CSI in the plurality of uplink channels and in the scheduling order of the uplink channels in the first control information.

In some embodiments, in a case where the first information at least includes the time domain locations occupied by the uplink channels and the number of bits allowed to carry the CSI in the uplink channels, the processing unit 430 is configured to:
select the at least one uplink channel that meets a transmission requirement of the CSI to be transmitted in sequence from the plurality of uplink channels, in order from large to small of the number of bits allowed to carry the CSI in the plurality of uplink channels and in second order of locations of starting symbols occupied by the plurality of uplink channels in time domain.

In some embodiments, in a case where the first information at least includes the number of bits allowed to carry the CSI in the uplink channels and the preparation time of the CSI to be transmitted, the processing unit 430 is configured to:
select the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels.

In some embodiments, in a case where the first information at least includes the carrier information associated with the uplink channels, the number of bits allowed to carry the CSI in the uplink channels, and the preparation time of the CSI to be transmitted, the processing unit 430 is configured to:
select the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in first order of carrier identifiers associated with the uplink channels.

In some embodiments, in a case where the first information at least includes the scheduling order of the uplink channels in the first control information, the number of bits allowed to carry the CSI in the uplink channels, and the preparation time of the CSI to be transmitted, the processing unit 430 is configured to:
select the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in the scheduling order of the uplink channels in the first control information.

In some embodiments, in a case where the first information at least includes the time domain locations occupied by the uplink channels, the number of bits allowed to carry the CSI in the uplink channels, and the preparation time of the CSI to be transmitted, the processing unit 430 is configured to:
select the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in second order of locations of starting symbols occupied by the plurality of uplink channels in time domain.

In some embodiments, in a case where the number of bits allowed to carry the CSI in one uplink channel determined from the plurality of uplink channels based on the first information is less than a number of bits of the CSI to be transmitted, a number of the at least one uplink channel is greater than or equal to 2.

In some embodiments, in a case where only one CSI trigger field exists in the first control information, a correspondence between the CSI triggering field and CSI reporting is configured by a network device through a high layer signaling.

In some embodiments, the CSI to be transmitted includes all CSI to be transmitted, or the CSI to be transmitted includes a first part of all CSI to be transmitted.

In some embodiments, the CSI to be transmitted is aperiodic CSI, or the CSI to be transmitted is semi-persistent CSI.

In some embodiments, the communication unit above may be a communication interface or a transceiver, or an input/output interface of a communication chip or a system on chip. The processing unit above may be one or more processors.

It should be understood that the network device 400 according to the embodiments of the present application may correspond to the network device in the method embodiments of the present application, and the above-mentioned and other operations and/or functions of various units in the network device 400 are respectively for implementing the corresponding processes of the network device in the method 200 shown in FIG. 2, which will not be repeated here for the sake of brevity.

FIG. 5 is a schematic structural diagram of a communication device 500 provided in the embodiments of the present application. The communication device 500 shown in FIG. 5 includes a processor 510, and the processor 510 may invoke a computer program from a memory and execute the computer program, to implement the method in the embodiments of the present application.

In some embodiments, as shown in FIG. 5, the communication device 500 further includes a memory 520. Herein, the processor 510 may invoke and execute a computer program from the memory 520 to implement the method in the embodiments of the present application.

Herein, the memory 520 may be a separate device independent from the processor 510, or may also be integrated into the processor 510.

In some embodiments, as shown in FIG. 20, the communication device 500 may also include a transceiver 530, and the processor 510 may control the transceiver 530 to communicate with other devices, and for example, to transmit information or data to other devices, or receive information or data transmitted by other devices.

Herein, the transceiver 530 may include a transmitter and a receiver. The transceiver 530 may further include antennas, and the number of antennas may be one or more.

In some embodiments, the processor 510 may implement the functions of the processing unit 330 in the terminal device 300, or the processor 510 may implement the functions of the processing unit 430 in the network device 400, which will not be repeated here for the sake of brevity.

In some embodiments, the transceiver 530 may implement the functions of the first communication unit 310 and/or the second communication unit 320 in the terminal device 300, which will not be repeated here for the sake of brevity.

In some embodiments, the transceiver 530 may implement the functions of the first communication unit 410 and/or the second communication unit 420 in the network device 400, which will not be repeated here for the sake of brevity.

In some embodiments, the communication device 500 may be the network device of the embodiments of the present application, and the communication device 500 may implement the corresponding processes implemented by the network device in various methods of the embodiments of the present application, which will not be repeated here for the sake of brevity.

In some embodiments, the communication device 500 may be the terminal device of the embodiments of the present application, and the communication device 500 may implement the corresponding processes implemented by the terminal device in various methods of the embodiments of the present application, which will not be repeated here for the sake of brevity.

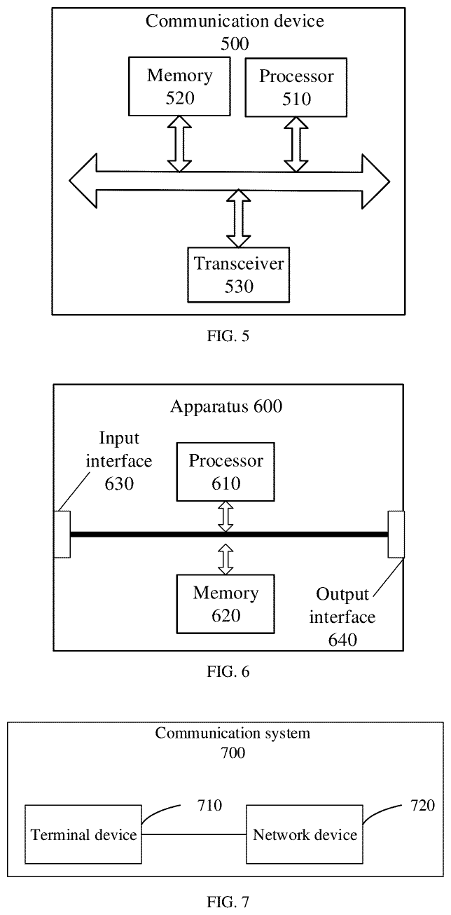

FIG. 6 is a schematic structural diagram of an apparatus of the embodiments of the present application. The apparatus 600 shown in FIG. 6 includes a processor 610, the processor 610 may invoke and execute a computer program from a memory to implement the method in the embodiments of the present application.

In some embodiments, as shown in FIG. 6, the apparatus 600 may further include a memory 620. Herein, the processor 610 may invoke and execute a computer program from the memory 620 to implement the method in the embodiments of the present application.

Herein, the memory 620 may be a separate device independent from the processor 610, or may also be integrated into the processor 610.

In some embodiments, the apparatus 600 may further include an input interface 630. Herein, the processor 610 may control the input interface 630 to communicate with other devices or chips, and for example, the input interface 630 may acquire information or data sent by other devices or chips.

In some embodiments, the processor 610 may implement the functions of the processing unit 330 in the terminal device 300, or the processor 610 may implement the functions of the processing unit 430 in the network device 400, which will not be repeated here for the sake of brevity.

In some embodiments, the input interface 630 may implement the functions of the first communication unit 310 in the terminal device 300, or the input interface 630 may implement the functions of the second communication unit 420 in the network device 400.

In some embodiments, the apparatus 600 may further include an output interface 640. Herein, the processor 610 may control the output interface 640 to communicate with other devices or chips, and for example, the output interface 640 may output information or data to other devices or chips.

In some embodiments, the output interface 640 may implement the functions of the second communication unit 320 in the terminal device 300, or the output interface 640 may implement the functions of the first communication unit 410 in the network device 400.

In some embodiments, the apparatus may be applied to the network device in the embodiments of the present application, and the apparatus may implement the corresponding procedure implemented by the network device in the various methods of the embodiments of the present application, which will not be repeated here for the sake of brevity.

In some embodiments, the apparatus may be applied to the terminal device in the embodiments of the present application, and the apparatus may implement the corresponding procedure implemented by the terminal device in the various methods of the embodiments of the present application, which will not be repeated here for the sake of brevity.

In some embodiments, the apparatus mentioned in the embodiments of the present application may also be a chip. For example, it may be a system on chip, a system chip, a chip system or a system-on-chip chip, etc.

FIG. 7 is a schematic block diagram of a communication system 700 provided in the embodiments of the present application. As shown in FIG. 7, the communication system 700 includes a terminal device 710 and a network device 720.

Herein, the terminal device 710 may be configured to implement the corresponding functions implemented by the terminal device in the aforementioned methods, and the network device 720 may be configured to implement the corresponding functions implemented by the network device in the aforementioned methods, which will not be repeated here for the sake of brevity.

It should be understood that the processor in the embodiments of the present application may be an integrated circuit chip and have a processing capability of signals. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present application may be implemented or performed. A general-purpose processor may be a microprocessor, or the processor may also be any conventional processor, etc. The steps of the method disclosed in combination with the embodiments of the present application may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that, the memory in the embodiments of the present application may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein is intended to include, but not limited to, these and any other suitable types of memories.

It should be understood that the above memory is exemplary but not limiting illustration, e.g., the memory in embodiments of the present application may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present application is intended to include, but not limited to, these and any other suitable types of memories.

The embodiments of the present application further provide a non-transitory computer-readable storage medium for storing a computer program.

In some embodiments, the non-transitory computer-readable storage medium may be applied to the network device in the embodiments of the present application, and the computer program causes a computer to perform the corresponding procedure implemented by the network device in the various methods of the embodiments of the present application, which will not be repeated here for the sake of brevity.

In some embodiments, the non-transitory computer-readable storage medium may be applied to the terminal device in the embodiments of the present application, and the computer program causes a computer to perform the corresponding procedure implemented by the terminal device in various methods of the embodiments of the present application, which will not be repeated here for the sake of brevity.

The embodiments of the present application further provide a computer program product including a computer program instruction.

In some embodiments, the computer program product may be applied to the network device in the embodiments of the present application, and the computer program instruction causes a computer to perform the corresponding procedure implemented by the network device in the various methods of the embodiments of the present application, which will not be repeated here for the sake of brevity.

In some embodiments, the computer program product may be applied to the terminal device in the embodiments of the present application, and the computer program instruction causes a computer to perform the corresponding procedure implemented by the terminal device in various methods of the embodiments of the present application, which will not be repeated here for the sake of brevity.

The embodiments of the present application further provide a computer program.

In some embodiments, the computer program may be applied to the network device in the embodiments of the present application, the computer program when being executed on a computer, causes the computer to perform the corresponding procedure implemented by the network device in various methods of the embodiments of the present application, which will not be repeated here for the sake of brevity.

In some embodiments, the computer program may be applied to the terminal device in the embodiments of the present application, the computer program when being executed on a computer, causes the computer to perform the corresponding procedure implemented by the terminal device in various methods of the embodiments of the present application, which will not be repeated here for the sake of brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on an application and a design constraint of the technical solution. A skilled person may use different methods for each application, to implement the described functions, but such implementation should not be considered beyond the scope of the present application.

It may be clearly understood by those skilled in the art that, for convenience and brevity of the description, the working procedures of the system, the apparatus and the unit described above may refer to the corresponding procedures in the above method embodiments, which will not be repeated here.

In the several embodiments provided by the application, it should be understood that, the disclosed systems, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present application may be integrated into one processing unit, or the various units may exist physically separately, or two or more units may be integrated into one unit.

If the described functions are implemented in the form of a software functional unit and sold or used as an independent product, they may be stored in a non-transitory computer-readable storage medium. For this understanding, the technical solution of the present application essentially, or a part of the technical solution that contributes to the prior art, or a part of the technical solution, may be embodied in the form of a software product, and the computer software product is stored in a storage medium, and includes a plurality of instructions for enabling a computer device (which may be a personal computer, a server, or a network device, etc.) to perform all or some of steps of the methods described in the various embodiments of the present application. And, the storage medium mentioned above includes a USB flash drive (U disk), a mobile hard disk, a Read-Only Memory (ROM), a Random Access Memory (RAM), a diskette, or an optical disk, and various mediums that may store program codes.

The above content is only exemplary implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A wireless communication method, comprising:
receiving, by a terminal device, first control information, wherein the first control information is used to schedule a plurality of uplink channels, and different uplink channels of the plurality of uplink channels are carried by different carriers; and
transmitting at least, by the terminal device, at least one uplink channel of the plurality of uplink channels, wherein the at least one uplink channel carries channel state information (CSI) to be transmitted.

2. The method according to claim 1, wherein the method further comprises:
determining, by the terminal device, the at least one uplink channel from the plurality of uplink channels according to first information;
wherein the first information comprises at least one of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

3. The method according to claim 2, wherein
in a case where the first information at least comprises the indication information carried in the first control information, the first control information comprises a first information field, wherein the first information field is used to indicate an identifier of an uplink channel used to carry the CSI in the plurality of uplink channels, or the first information field is used to indicate an identifier of a carrier associated with an uplink channel used to carry the CSI in the plurality of uplink channels;
wherein the determining, by the terminal device, the at least one uplink channel from the plurality of uplink channels according to the first information, comprises:
determining, by the terminal device, the at least one uplink channel from the plurality of uplink channels according to the first information field;
or
in a case where the first information at least comprises the indication information carried in the first control information, the first control information comprises at least one second information field, wherein the at least one second information field corresponds to the at least one uplink channel respectively, or the at least one second information field corresponds to a carrier associated with the at least one uplink channel respectively;
wherein the determining, by the terminal device, the at least one uplink channel from the plurality of uplink channels according to the first information, comprises:
determining, by the terminal device, the at least one uplink channel from the plurality of uplink channels according to the at least one second information field.

4. The method according to claim 2, wherein
in a case where the first information at least comprises the carrier information associated with the uplink channels, the determining, by the terminal device, the at least one uplink channel from the plurality of uplink channels according to the first information, comprises:
selecting, by the terminal device, the at least one uplink channel used to carry the CSI in sequence from the plurality of uplink channels in first order of carrier identifiers associated with the uplink channels;
or
in a case where the first information at least comprises the scheduling order of the uplink channels in the first control information, the determining, by the terminal device, the at least one uplink channel from the plurality of uplink channels according to the first information, comprises:
selecting, by the terminal device, the at least one uplink channel used to carry the CSI in sequence from the plurality of uplink channels in the scheduling order of the uplink channels in the first control information;
or
in a case where the first information at least comprises the time domain locations occupied by the uplink channels, the determining, by the terminal device, the at least one uplink channel from the plurality of uplink channels according to the first information, comprises:
selecting, by the terminal device, the at least one uplink channel used to carry the CSI in sequence from the plurality of uplink channels in second order of locations of starting symbols occupied by the plurality of uplink channels in time domain;
or
in a case where the first information at least comprises the preparation time of the CSI to be transmitted, the determining, by the terminal device, the at least one uplink channel from the plurality of uplink channels according to the first information, comprises:
selecting, by the terminal device, the at least one uplink channel from an uplink channel for which an interval between a starting symbol of the uplink channel and a last symbol of the first control information is greater than or equal to the preparation time of the CSI to be transmitted, in the plurality of uplink channels;
or
in a case where the first information at least comprises the number of bits allowed to carry the CSI in the uplink channels, the determining, by the terminal device, the at least one uplink channel from the plurality of uplink channels according to the first information, comprises:
selecting, by the terminal device, the at least one uplink channel that meets a transmission requirement of the CSI to be transmitted from the plurality of uplink channels in order from large to small of the number of bits allowed to carry the CSI in the plurality of uplink channels;
or
in a case where the first information at least comprises the priorities of the uplink channels, the determining, by the terminal device, the at least one uplink channel from the plurality of uplink channels according to the first information, comprises:
selecting, by the terminal device, the at least one uplink channel used to carry the CSI in sequence from the plurality of uplink channels in order of priorities of the plurality of uplink channels.

5. The method according to claim 2, wherein
in a case where the first information at least comprises the priorities of the uplink channels and the priority of the CSI, the determining, by the terminal device, the at least one uplink channel from the plurality of uplink channels according to the first information, comprises:
selecting, by the terminal device, the at least one uplink channel used to carry the CSI from an uplink channel having a same priority as the priority of the CSI, in the plurality of uplink channels;
or
in a case where the first information at least comprises the carrier information associated with the uplink channels and the preparation time of the CSI to be transmitted, the determining, by the terminal device, the at least one uplink channel from the plurality of uplink channels according to the first information, comprises:
selecting, by the terminal device, the at least one uplink channel in sequence from an uplink channel for which an interval between a starting symbol of the uplink channel and a last symbol of the first control information is greater than or equal to the preparation time of the CSI to be transmitted in the plurality of uplink channels, in first order of carrier identifiers associated with the uplink channels;
or
in a case where the first information at least comprises the scheduling order of the uplink channels in the first control information and the preparation time of the CSI to be transmitted, the determining, by the terminal device, the at least one uplink channel from the plurality of uplink channels according to the first information, comprises:
selecting, by the terminal device, the at least one uplink channel in sequence from an uplink channel for which an interval between a starting symbol of the uplink channel and a last symbol of the first control information is greater than or equal to the preparation time of the CSI to be transmitted in the plurality of uplink channels, in the scheduling order of the uplink channels in the first control information;
or
in a case where the first information at least comprises the time domain locations occupied by the uplink channels and the preparation time of the CSI to be transmitted, the determining, by the terminal device, the at least one uplink channel from the plurality of uplink channels according to the first information, comprises:
selecting, by the terminal device, the at least one uplink channel in sequence from an uplink channel for which an interval between a starting symbol of the uplink channel and a last symbol of the first control information is greater than or equal to the preparation time of the CSI to be transmitted in the plurality of uplink channels, in second order of locations of starting symbols occupied by the plurality of uplink channels in time domain;
or
in a case where the first information at least comprises the carrier information associated with the uplink channels and the number of bits allowed to carry the CSI in the uplink channels, the determining, by the terminal device, the at least one uplink channel from the plurality of uplink channels according to the first information, comprises:
selecting, by the terminal device, the at least one uplink channel that meets a transmission requirement of the CSI to be transmitted from the plurality of uplink channels, in order from large to small of the number of bits allowed to carry the CSI in the plurality of uplink channels and in first order of carrier identifiers associated with the uplink channels;
or
in a case where the first information at least comprises the scheduling order of the uplink channels in the first control information and the number of bits allowed to carry the CSI in the uplink channels, determining, by the terminal device, the at least one uplink channel from the plurality of uplink channels according to the first information, comprises:
selecting, by the terminal device, the at least one uplink channel that meets a transmission requirement of the CSI to be transmitted from the plurality of uplink channels, in order from large to small of the number of bits allowed to carry the CSI in the plurality of uplink channels and in the scheduling order of the uplink channels in the first control information;
or
in a case where the first information at least comprises the time domain locations occupied by the uplink channels and the number of bits allowed to carry the CSI in the uplink channels, the determining, by the terminal device, the at least one uplink channel from the plurality of uplink channels according to the first information, comprises:
selecting, by the terminal device, the at least one uplink channel that meets a transmission requirement of the CSI to be transmitted from the plurality of uplink channels, in order from large to small of the number of bits allowed to carry the CSI in the plurality of uplink channels and in second order of locations of starting symbols occupied by the plurality of uplink channels in time domain;
or
in a case where the first information at least comprises the number of bits allowed to carry the CSI in the uplink channels and the preparation time of the CSI to be transmitted, the determining, by the terminal device, the at least one uplink channel from the plurality of uplink channels according to the first information, comprises:
selecting, by the terminal device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels.

6. The method according to claim 2, wherein
in a case where the first information at least comprises the carrier information associated with the uplink channels, the number of bits allowed to carry the CSI in the uplink channels, and the preparation time of the CSI to be transmitted, the determining, by the terminal device, the at least one uplink channel from the plurality of uplink channels according to the first information, comprises:
selecting, by the terminal device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in first order of carrier identifiers associated with the uplink channels;
or
in a case where the first information at least comprises the scheduling order of the uplink channels in the first control information, the number of bits allowed to carry the CSI in the uplink channels, and the preparation time of the CSI to be transmitted, the determining, by the terminal device, the at least one uplink channel from the plurality of uplink channels according to the first information, comprises:
selecting, by the terminal device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in the scheduling order of the uplink channels in the first control information;
or
in a case where the first information at least comprises the time domain locations occupied by the uplink channels, the number of bits allowed to carry the CSI in the uplink channels, and the preparation time of the CSI to be transmitted, the determining, by the terminal device, the at least one uplink channel from the plurality of uplink channels according to the first information, comprises:
selecting, by the terminal device, the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in second order of locations of starting symbols occupied by the plurality of uplink channels in time domain.

7. The method according to claim 1, wherein in a case where only one CSI trigger field exists in the first control information, a correspondence between the CSI triggering field and CSI reporting is configured by a network device through a high layer signaling.

8. The method according to claim 2, wherein the CSI to be transmitted comprises all CSI to be transmitted, or the CSI to be transmitted comprises a first part of all CSI to be transmitted;
the CSI to be transmitted is aperiodic CSI, or the CSI to be transmitted is semi-persistent CSI.

9. A terminal device, comprising: a processor and a memory, wherein the memory is configured to store a computer program, and the processor is configured to invoke and execute the computer program stored in the memory, to cause the terminal device to perform:
receiving first control information, wherein the first control information is used to schedule a plurality of uplink channels, and different uplink channels of the plurality of uplink channels are carried by different carriers; and
at least transmitting at least one uplink channel of the plurality of uplink channels, wherein the at least one uplink channel carries channel state information (CSI) to be transmitted.

10. The terminal device according to claim 9, wherein the terminal device further performs:
determining the at least one uplink channel from the plurality of uplink channels according to first information;
wherein the first information comprises at least one of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

11. The terminal device according to claim 10, wherein
in a case where the first information at least comprises the indication information carried in the first control information, the first control information comprises a first information field, wherein the first information field is used to indicate an identifier of an uplink channel used to carry the CSI in the plurality of uplink channels, or the first information field is used to indicate an identifier of a carrier associated with an uplink channel used to carry the CSI in the plurality of uplink channels;
wherein the terminal device performs:
determining the at least one uplink channel from the plurality of uplink channels according to the first information field;
or
in a case where the first information at least comprises the indication information carried in the first control information, the first control information comprises at least one second information field, wherein the at least one second information field corresponds to the at least one uplink channel respectively, or the at least one second information field corresponds to a carrier associated with the at least one uplink channel respectively;
wherein the terminal device performs:
determining the at least one uplink channel from the plurality of uplink channels according to the at least one second information field.

12. The terminal device according to claim 10, wherein
in a case where the first information at least comprises the carrier information associated with the uplink channels, the terminal device performs:
selecting the at least one uplink channel used to carry the CSI in sequence from the plurality of uplink channels in first order of carrier identifiers associated with the uplink channels;
or
in a case where the first information at least comprises the scheduling order of the uplink channels in the first control information, the terminal device performs:
selecting the at least one uplink channel used to carry the CSI in sequence from the plurality of uplink channels in the scheduling order of the uplink channels in the first control information;
or
in a case where the first information at least comprises the time domain locations occupied by the uplink channels, the terminal device performs:
selecting the at least one uplink channel used to carry the CSI in sequence from the plurality of uplink channels in second order of locations of starting symbols occupied by the plurality of uplink channels in time domain;
or
in a case where the first information at least comprises the preparation time of the CSI to be transmitted, the terminal device performs:
selecting the at least one uplink channel from an uplink channel for which an interval between a starting symbol of the uplink channel and a last symbol of the first control information is greater than or equal to the preparation time of the CSI to be transmitted, in the plurality of uplink channels;
or
in a case where the first information at least comprises the number of bits allowed to carry the CSI in the uplink channels, the terminal device performs:
selecting the at least one uplink channel that meets a transmission requirement of the CSI to be transmitted from the plurality of uplink channels in order from large to small of the number of bits allowed to carry the CSI in the plurality of uplink channels;
or
in a case where the first information at least comprises the priorities of the uplink channels, the terminal device performs:
selecting the at least one uplink channel used to carry the CSI in sequence from the plurality of uplink channels in order of priorities of the plurality of uplink channels.

13. The terminal device according to claim 10, wherein
in a case where the first information at least comprises the priorities of the uplink channels and the priority of the CSI, the terminal device performs:
selecting the at least one uplink channel used to carry the CSI from an uplink channel having a same priority as the priority of the CSI, in the plurality of uplink channels;
or
in a case where the first information at least comprises the carrier information associated with the uplink channels and the preparation time of the CSI to be transmitted, the terminal device performs:
selecting the at least one uplink channel in sequence from an uplink channel for which an interval between a starting symbol of the uplink channel and a last symbol of the first control information is greater than or equal to the preparation time of the CSI to be transmitted in the plurality of uplink channels, in first order of carrier identifiers associated with the uplink channels;
or
in a case where the first information at least comprises the scheduling order of the uplink channels in the first control information and the preparation time of the CSI to be transmitted, the terminal device performs:
selecting the at least one uplink channel in sequence from an uplink channel for which an interval between a starting symbol of the uplink channel and a last symbol of the first control information is greater than or equal to the preparation time of the CSI to be transmitted in the plurality of uplink channels, in the scheduling order of the uplink channels in the first control information;
or
in a case where the first information at least comprises the time domain locations occupied by the uplink channels and the preparation time of the CSI to be transmitted, the terminal device performs:
selecting the at least one uplink channel in sequence from an uplink channel for which an interval between a starting symbol of the uplink channel and a last symbol of the first control information is greater than or equal to the preparation time of the CSI to be transmitted in the plurality of uplink channels, in second order of locations of starting symbols occupied by the plurality of uplink channels in time domain;
or
in a case where the first information at least comprises the carrier information associated with the uplink channels and the number of bits allowed to carry the CSI in the uplink channels, the terminal device performs:
selecting the at least one uplink channel that meets a transmission requirement of the CSI to be transmitted from the plurality of uplink channels, in order from large to small of the number of bits allowed to carry the CSI in the plurality of uplink channels and in first order of carrier identifiers associated with the uplink channels;
or
in a case where the first information at least comprises the scheduling order of the uplink channels in the first control information and the number of bits allowed to carry the CSI in the uplink channels, the terminal device performs:
selecting the at least one uplink channel that meets a transmission requirement of the CSI to be transmitted from the plurality of uplink channels, in order from large to small of the number of bits allowed to carry the CSI in the plurality of uplink channels and in the scheduling order of the uplink channels in the first control information;
or
in a case where the first information at least comprises the time domain locations occupied by the uplink channels and the number of bits allowed to carry the CSI in the uplink channels, the terminal device performs:
selecting the at least one uplink channel that meets a transmission requirement of the CSI to be transmitted from the plurality of uplink channels, in order from large to small of the number of bits allowed to carry the CSI in the plurality of uplink channels and in second order of locations of starting symbols occupied by the plurality of uplink channels in time domain;
or
in a case where the first information at least comprises the number of bits allowed to carry the CSI in the uplink channels and the preparation time of the CSI to be transmitted, the terminal device performs:
selecting the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels.

14. The terminal device according to claim 10, wherein
in a case where the first information at least comprises the carrier information associated with the uplink channels, the number of bits allowed to carry the CSI in the uplink channels, and the preparation time of the CSI to be transmitted, the terminal device performs:
selecting the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in first order of carrier identifiers associated with the uplink channels;
or
in a case where the first information at least comprises the scheduling order of the uplink channels in the first control information, the number of bits allowed to carry the CSI in the uplink channels, and the preparation time of the CSI to be transmitted, the terminal device performs:
selecting the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in the scheduling order of the uplink channels in the first control information;
or
in a case where the first information at least comprises the time domain locations occupied by the uplink channels, the number of bits allowed to carry the CSI in the uplink channels, and the preparation time of the CSI to be transmitted, the terminal device performs:
selecting the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in second order of locations of starting symbols occupied by the plurality of uplink channels in time domain.

15. A network device, comprising: a processor and a memory, wherein the memory is configured to store a computer program, and the processor is configured to invoke and execute the computer program stored in the memory, to cause the network device to perform:
transmitting first control information, wherein the first control information is used to schedule a plurality of uplink channels, and different uplink channels of the plurality of uplink channels are carried by different carriers; and
at least receiving at least one uplink channel of the plurality of uplink channels, wherein the at least one uplink channel carries channel state information (CSI) to be transmitted.

16. The network device according to claim 15, wherein the network device further performs:
determining the at least one uplink channel from the plurality of uplink channels according to first information;
wherein the first information comprises at least one of the following:
carrier information associated with uplink channels, time domain locations occupied by uplink channels, preparation time of the CSI to be transmitted, a number of bits allowed to carry the CSI in uplink channels, priorities of uplink channels, a priority of the CSI, scheduling order of uplink channels in the first control information, or indication information carried in the first control information.

17. The network device according to claim 16, wherein
in a case where the first information at least comprises the indication information carried in the first control information, the first control information comprises a first information field, wherein the first information field is used to indicate an identifier of an uplink channel used to carry the CSI in the plurality of uplink channels, or the first information field is used to indicate an identifier of a carrier associated with an uplink channel used to carry the CSI in the plurality of uplink channels;
wherein the network device performs:
determining the at least one uplink channel from the plurality of uplink channels according to the first information field;
or
in a case where the first information at least comprises the indication information carried in the first control information, the first control information comprises at least one second information field, wherein the at least one second information field corresponds to the at least one uplink channel respectively, or the at least one second information field corresponds to a carrier associated with the at least one uplink channel respectively;
wherein the network device performs:
determining the at least one uplink channel from the plurality of uplink channels according to the at least one second information field.

18. The network device of claim 16, wherein
in a case where the first information at least comprises the carrier information associated with the uplink channels, the network device performs:
selecting the at least one uplink channel used to carry the CSI in sequence from the plurality of uplink channels in first order of carrier identifiers associated with the uplink channels;
or
in a case where the first information at least comprises the scheduling order of the uplink channels in the first control information, the network device performs:
selecting the at least one uplink channel used to carry the CSI in sequence from the plurality of uplink channels in the scheduling order of the uplink channels in the first control information;
or
in a case where the first information at least comprises the time domain locations occupied by the uplink channels, the network device performs:
selecting the at least one uplink channel used to carry the CSI in sequence from the plurality of uplink channels in second order of locations of starting symbols occupied by the plurality of uplink channels in time domain;
or
in a case where the first information at least comprises the preparation time of the CSI to be transmitted, the network device performs:
selecting the at least one uplink channel from an uplink channel for which an interval between a starting symbol of the uplink channel and a last symbol of the first control information is greater than or equal to the preparation time of the CSI to be transmitted, in the plurality of uplink channels;
or
in a case where the first information at least comprises the number of bits allowed to carry the CSI in the uplink channels, the network device performs:
selecting the at least one uplink channel that meets a transmission requirement of the CSI to be transmitted from the plurality of uplink channels in order from large to small of the number of bits allowed to carry the CSI in the plurality of uplink channels;
or
in a case where the first information at least comprises the priorities of the uplink channels, the network device performs:
selecting the at least one uplink channel used to carry the CSI in sequence from the plurality of uplink channels in order of priorities of the plurality of uplink channels.

19. The network device of claim 16, wherein
in a case where the first information at least comprises the priorities of the uplink channels and the priority of the CSI, the network device performs:
selecting the at least one uplink channel used to carry the CSI from an uplink channel having a same priority as the priority of the CSI, in the plurality of uplink channels;
or
in a case where the first information at least comprises the carrier information associated with the uplink channels and the preparation time of the CSI to be transmitted, the network device performs:
selecting the at least one uplink channel in sequence from an uplink channel for which an interval between a starting symbol of the uplink channel and a last symbol of the first control information is greater than or equal to the preparation time of the CSI to be transmitted in the plurality of uplink channels, in first order of carrier identifiers associated with the uplink channels;
in a case where the first information at least comprises the scheduling order of the uplink channels in the first control information and the preparation time of the CSI to be transmitted, the network device performs:
selecting the at least one uplink channel in sequence from an uplink channel for which an interval between a starting symbol of the uplink channel and a last symbol of the first control information is greater than or equal to the preparation time of the CSI to be transmitted in the plurality of uplink channels, in the scheduling order of the uplink channels in the first control information;
or
in a case where the first information at least comprises the time domain locations occupied by the uplink channels and the preparation time of the CSI to be transmitted, the network device performs:
selecting the at least one uplink channel in sequence from an uplink channel for which an interval between a starting symbol of the uplink channel and a last symbol of the first control information is greater than or equal to the preparation time of the CSI to be transmitted in the plurality of uplink channels, in second order of locations of starting symbols occupied by the plurality of uplink channels in time domain;
or
in a case where the first information at least comprises the carrier information associated with the uplink channels and the number of bits allowed to carry the CSI in the uplink channels, the network device performs:
selecting the at least one uplink channel that meets a transmission requirement of the CSI to be transmitted from the plurality of uplink channels, in order from large to small of the number of bits allowed to carry the CSI in the plurality of uplink channels and in first order of carrier identifiers associated with the uplink channels;
or
in a case where the first information at least comprises the scheduling order of the uplink channels in the first control information and the number of bits allowed to carry the CSI in the uplink channels, the network device performs:
selecting the at least one uplink channel that meets a transmission requirement of the CSI to be transmitted from the plurality of uplink channels, in order from large to small of the number of bits allowed to carry the CSI in the plurality of uplink channels and in the scheduling order of the uplink channels in the first control information;
or
in a case where the first information at least comprises the time domain locations occupied by the uplink channels and the number of bits allowed to carry the CSI in the uplink channels, the network device performs:
selecting the at least one uplink channel that meets a transmission requirement of the CSI to be transmitted from the plurality of uplink channels, in order from large to small of the number of bits allowed to carry the CSI in the plurality of uplink channels and in second order of locations of starting symbols occupied by the plurality of uplink channels in time domain;
or
in a case where the first information at least comprises the number of bits allowed to carry the CSI in the uplink channels and the preparation time of the CSI to be transmitted, the network device performs:
selecting the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels.

20. The network device of claim 16, wherein
in a case where the first information at least comprises the carrier information associated with the uplink channels, the number of bits allowed to carry the CSI in the uplink channels, and the preparation time of the CSI to be transmitted, the network device performs:
selecting the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in first order of carrier identifiers associated with the uplink channels;
or
in a case where the first information at least comprises the scheduling order of the uplink channels in the first control information, the number of bits allowed to carry the CSI in the uplink channels, and the preparation time of the CSI to be transmitted, the network device performs:
selecting the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in the scheduling order of the uplink channels in the first control information;
or
in a case where the first information at least comprises the time domain locations occupied by the uplink channels, the number of bits allowed to carry the CSI in the uplink channels, and the preparation time of the CSI to be transmitted, the network device performs:
selecting the at least one uplink channel that meets a transmission requirement of the CSI to be transmitted from an uplink channel for which an interval between a starting symbol of the uplink channel and a last symbol of the first control information is greater than or equal to the preparation time of the CSI to be transmitted in the plurality of uplink channels, in order from large to small of the number of bits allowed to carry the CSI in the plurality of uplink channels and in second order of locations of starting symbols occupied by the plurality of uplink channels in time domain.
